(19) United States
(12) Patent Application Publication
(10) Pub. No.: US 2008/0021770 A1
(43) Pub. Date: Jan. 24, 2008

(54) Method and System for Monitoring Status of Vehicle Parking Spaces

(76) Inventors: Alan Mourton, Stonehouse (GB); Sandy Mace, Cirencester (GB)

Correspondence Address: GORDON & JACOBSON, P.C., 60 LONG RIDGE ROAD, SUITE 407, STAMFORD, CT, 06902, US

(21) Appl. No.: 11/458,496

(22) Filed: Jul. 19, 2006

(30) Foreign Application Priority Data
Jul. 6, 2006 (GB) GB 0613465.4

(51) Int. Cl. G07B 15/00

(52) U.S. Cl. 705/13

(57) ABSTRACT

A method and system for monitoring the status of vehicle parking spaces. A server receives data transmitted over a network from at least one ticketing machine useable to purchase parking time for the parking spaces. The data comprises identity information identifying individual parking spaces for which parking time has been purchased and information relating to the purchased parking time for each identified parking space. The server transmits status information to a portable terminal regarding the parking spaces for presentation to a user of the terminal, the information depending upon the data received at the server. The status information may identify spaces for which no parking time is currently purchased, or for which purchased parking time has recently expired. The user may use the status information to enforce the purchase of parking time for the spaces. The system also generates an ID number for each transaction, the ID number encoding information identifying the parking space and expiry time relating to the transaction. A customer may later input an ID number to a ticketing machine in order to validly purchase additional parking time for the parking space to extend the initial expiry time.

### BACKGROUND OF THE INVENTION

1. Field of the Invention

The present invention relates to a method of operating a system for monitoring the status of vehicle parking spaces, for example, parking spaces in a car park.

2. State of the Art

So called ‘Pay and Display’ car parks are well known. A ‘Pay and Display’ car park is typically provided with one or more ticket machines from which a user can obtain a ticket in order to validly park their car in the car park for a purchased time period. Normally, the time by which the user's car must leave the car park is printed on the ticket and the user is expected to display the ticket through a window of their car. Typically, the operator of such a car park employs parking staff to patrol the cark park and visually check that valid tickets are displayed in the parked cars. It is commonplace for the car park operator to fine the owners of parked cars identified as either not displaying a ticket or displaying a ticket for which the purchased time period has expired.

Also known are car park management systems in which the ticket machines in a car park are linked via a communications network to a central office management server. Operational data concerning the ticket machines can be transmitted from the ticket machines to the server for storage and subsequent presentation (for example on a computer monitor) to an operator. The operational data may for example indicate that a particular ticket machine has malfunctioned, and hence the operator can dispatch an engineer to repair the ticket machine. However, such known systems do not assist car park operators in enforcing the parking of cars in their car parks.

### SUMMARY OF THE INVENTION

An improved system has been devised.

According to one aspect of the present invention there is provided a method of operating a system for monitoring a status of vehicle parking spaces, said method comprising: receiving at a server data transmitted over a network from at least one apparatus useable to purchase parking time for the parking spaces, the data comprising identity information identifying individual parking spaces for which parking time has been purchased and information relating to the purchased parking time for each identified parking space; transmitting from the server to a user terminal status information regarding said parking spaces for presentation to a user of said terminal, said information depending upon said data received at the server.

According to another aspect of the present invention there is provided a method of operating a system for monitoring a status of vehicle parking spaces, said method comprising: transmitting data from at least one apparatus useable to purchase parking time for the parking spaces over a network to a remote server, said data comprising identity information identifying individual parking spaces for which parking time has been purchased and information relating to the purchased parking time for each identified parking space; receiving at a user terminal status information regarding the parking spaces, said status information transmitted from said server and being dependent upon said data transmitted from said at least one apparatus, presenting said status information to a user of the terminal.

According to another aspect of the present invention there is provided, apparatus for monitoring a status of vehicle parking spaces, said apparatus comprising: a server for receiving data transmitted over a network from at least one device useable to purchase parking time for the parking spaces, said data comprising identity information identifying individual parking spaces for which parking time has been purchased and information relating to the purchased parking time for each identified parking space; and for transmitting to a user terminal status information regarding said parking spaces for presentation to a user of said terminal, the status information depending upon said data received at the server.

According to another aspect of the invention there is provided, apparatus for monitoring a status of vehicle parking spaces, said apparatus comprising: at least one device useable to purchase parking time for the parking spaces and for transmitting data over a network to a remote server, said data comprising identity information identifying individual parking spaces for which parking time has been purchased and information relating to the purchased parking time for each identified parking space; and at least one user terminal for receiving status information regarding the parking spaces transmitted from said server, said status information being dependent upon said data transmitted from said at least one apparatus, and wherein said user terminal is for presenting said status information to a user of said terminal.

According to another aspect of the invention there is provided a method of conducting a transaction for parking time for a parking space; said method comprising:
receiving as data input at an apparatus a first request from a user for a purchase of parking time for a parking space, said request including data identifying the parking space;
presenting an identification code to said user for subsequent use by said user to purchase additional parking time to extend a time period for the parking space purchased by said first request;
receiving as data input at an apparatus a second request from said user for a purchase of additional parking time to extend said purchased time period for said parking space, said second request including the identification code; and
checking the validity of said identification code to authorize the second request.

According to another aspect of the invention there is provided Apparatus for conducting a transaction for parking time for a parking space; the apparatus comprising:
means for receiving as data input a first request from a user for a purchase of parking time for a parking space, the request including data identifying the parking space;
means for presenting an identification code to said user for subsequent use by said user to purchase additional parking time to extend a time period for said parking space purchased by said first request;
means for receiving as data input a second request from said user for a purchase of additional parking time to extend the purchased time period for said parking space, the second request including said identification code; and
means for checking the validity of said identification code to authorize the second request.

An embodiment of the invention will now be described by way of example only with reference to the accompanying drawings.

### BRIEF DESCRIPTION OF THE DRAWINGS

FIG. 1 is a schematic diagram of a system embodying the present invention;

FIGS. 2a and 2b illustrate example ticket formats;

FIG. 2c illustrates a block diagram of a ticketing machine;

FIGS. 3 to 43 illustrate example browser windows;

FIG. 44 illustrates a schematic diagram summarizing the system's functionality.

### DETAILED DESCRIPTION OF THE PREFERRED EMBODIMENT

### System Overview

A specific embodiment of the present invention is a General Packet Radio Service (GPRS) and Internet based system in which parking machines communicate parking space purchase information at regular intervals over a mobile communications network to a remote web server at a central back office. Information depending upon the space purchase information can be viewed on an operator's terminal at the back office which accesses the web server and runs web browser software, which provides an interactive display. Furthermore, information depending upon the space purchase information may also be retrieved from the remote web server over the mobile communications network by at least one mobile terminal carried by an attendant patrolling the parking spaces. The mobile terminal also runs web browser software for providing an interactive display of the space purchase information. In a preferred embodiment the server transmits information to the mobile terminal each time a request is received from the mobile terminal's browser (i.e. the browser ‘pulls’ the information from the server). The protocols and infra structure used in a GPRS system are well known in the art as are the protocols by which web-based access is provided, for example http, html and TCP/IP and will not be further described except where necessary to explain a specific function of the system.

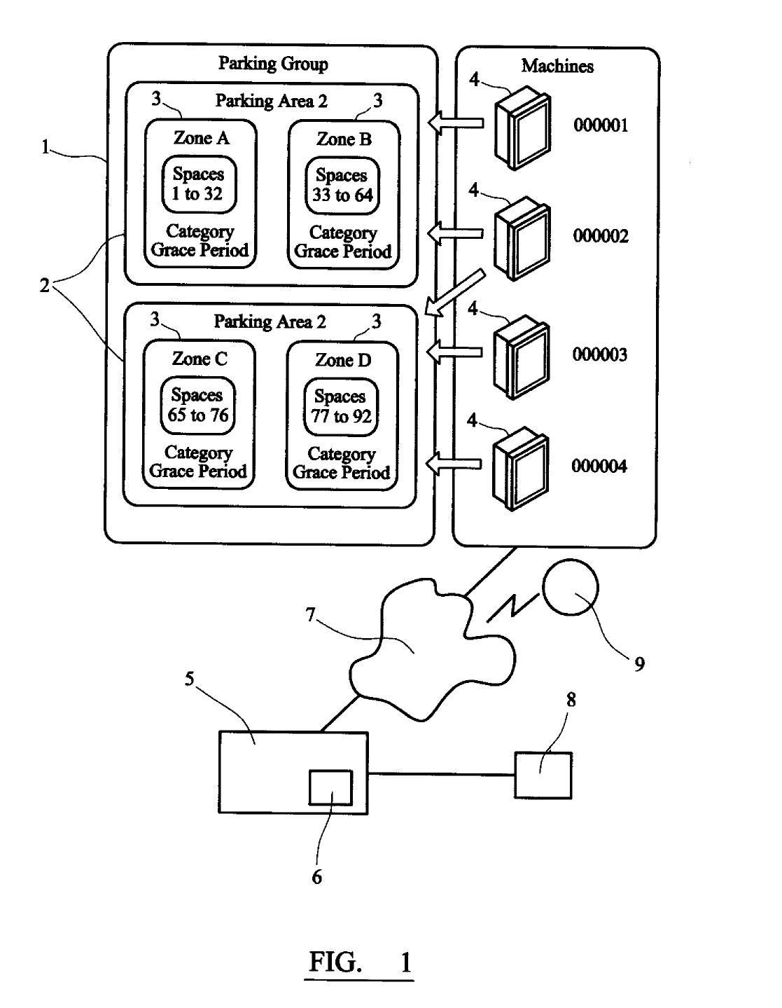

A payment car parking system embodying the present invention is shown in FIG. 1. The system comprises a parking group 1 comprising one or more parking areas 2, for example car parks. Each parking area 2 comprises one or more zones 3, each zone 3 comprising a plurality of uniquely numbered car parking spaces.

The system further comprises one or more ticketing machines 4 programmable to accept payment for parking in all the spaces available in the system 1 or to accept payment for all the spaces available in specific parking areas 2 only, if required. Car park users are able to use the ticketing machines 4 to purchase parking time for spaces administered by the ticketing machines 4. A user inputs into a ticketing machine 4 data, for example an identification number, identifying the particular parking space for which time is to be purchased. The user pays for the desired parking time by either feeding an appropriate amount coins or notes into a machine 4 or by inserting into the machine 4 a pre-payment card from which the machine debits the appropriate payment. The machine 4 prints a receipt for the user indicating the space number, the parking expiry time and in addition, an ID code which as will be explained in greater detail below, enables the user to purchase at a later time additional parking time for the space, without having to return to their vehicle.

The system also comprises a remote web server 5 and a database 6 stored on data storage. The web server 5 and database 6 may be located at the offices of a company that manages the parking areas 2. Typically, the server 5 and database 6 have the following specification: hardware; P4 2.8 Ghz processor, 1 Gb memory, 100 Gb HDD, operating system; Windows 2000 Server SP4 or Windows 2003 Server, SQL Server 2000 with SP3a, Microsoft IIS 5.0 or greater. It will however be appreciated that this specification can vary depending upon the requirements of the system.

The ticketing machines 4 are connectable to the web server 5 over an Internet connection using a GPRS system 7. At pre-defined configurable intervals, each parking machine 4 transmits to the web server 5 information regarding all the space purchasing transactions that have occurred since the machine last communicated with the web server 5. The information for each transaction includes, the identification number that identifies the particular parking space for which time has been purchased, the time at which parking time for the space was purchased, the expiry time for the space and the purchase price. The information received at the web server 5 from the ticketing machines 4 is stored in the database and updated each time the ticketing machines 4 communicate with the web server 5. Provided the update period is relatively short, the web server 5 can maintain a near ‘real time’ status of the system. Alternatively, each ticketing machine 4 may be configured to transmit the information for a transaction immediately after the transaction is completed. This coupled with the server's 5 ability to accept multiple concurrent connections to the ticketing machines 4 would allow the server 5 to maintain a true ‘real time’ status of the system.

The system further comprises a terminal 8, for example a desktop PC running a Microsoft Windows Operating System having a web browser for example Internet Explorer 5.5 or above. A user can use the web browser running on the terminal 8 to access the web server 5 to retrieve information from the database 6 for display at the terminal 8 in interactive web pages. This enables the user to monitor in real time the status of parking spaces in the parking areas 2. Typically, the terminal 8 is located at the same company offices as are the web server 5 and the database 6 although this need not be the case.

The system further comprises at least one portable terminal 9 carried by a parking attendant patrolling the parking spaces 2. The portable terminal 9 may for example be a Skeye Pad as produced by H'ft & Wessel running a web browser for example Internet Explorer 5.5 or above. Like the ticketing machines 4, the portable terminal 9 is connectable to the web server 5 over an Internet connection using the GPRS system 7. The parking attendant carrying the terminal 9 can thus use its web browser to access the web server 5 to retrieve information from the database 6 for display at the portable terminal 9 in interactive web pages. The information presentable to the parking attendant enables the attendant to identify occupied spaces for which no valid payment has been made thereby facilitating payment enforcement. Preferably, the parking attendant can use the portable terminal's browser to filter for information identifying recently expired, unpaid for or paid for spaces to further facilitate payment enforcement.

Each ticketing machine 4 also stores a local record of each transaction performed at that machine, so that a record of all transactions is kept. Thus, even in the event of a partial or total communications failure between the ticketing machines 4 and the server 5 or a failure of the server 5 or back office infrastructure, transactions may still be performed at the machines and a record of the transactions maintained. In the event of any such failure, information stored locally at the ticketing machines which otherwise would also have been transmitted to the server 5, may be transmitted after the failure is rectified.

Advantageously, the system increases the convenience of the customers parking their vehicles in the parking spaces because there is no need for them to display tickets in vehicle windows in the traditional way.

Furthermore, the system enables the operator of the parking areas to quickly and easily check that valid parking time has been purchased for particular spaces, without the need of inspecting tickets display in vehicle windows.

The system will now be described in more detail.

### Ticket Machine Operations and ‘ADD’ Operation

As mentioned in the overview, the system supports the option of allowing users to add parking time to an existing parking time purchase for a space. In order to prevent the operator of the parking areas 2 losing revenue due to this feature effectively giving new customers any unused time from previous customers, a unique ID number is printed on the receipt ticket issued by the ticketing machines 4. A customer wishing to add time to their original purchase is required to enter this ID number into a machine 4 prior to being able to perform the ‘Add’ operation.

To allow ‘Add’ operations to be performed even if network access to the web server 5 from the ticketing machines 4 is for some reason temporarily unavailable, the ID number printed on each ticket contains an encoded expiry time value and space number. This allows a ticket machine 4, when given a space number, to be able to add time to the original transaction and provides an effective global ‘Add’ facility at any ticket machine 4 without requiring a network of any kind to be available. Thus, a user is able to purchase additional time for a parking space in this way, from any ticketing machine 4, not just the machine 4 used for the initial purchase, even if access to the web server 5 is temporarily unavailable. Advantageously, the machine 4 used for the ‘Add’ operation may even be located outside of a car park, for example in a shopping mall, meaning that a user does not have to return to the car park to purchase additional time.

Requiring the input of a valid ID number to implement the ‘Add function’ prevents new customers making use of time actually purchased by previous customers, hence losing the operator revenue. This may be understood by way of the following example that assumes that the ‘Add’ function is enabled but no ID input is required.
1. Customer 1 arrives at 10 AM and purchases 2 hours for space 20 getting an expiry time of 12 PM.
2. Customer 1 leaves space 20 at 11 AM.
3. Customer 2 arrives at 11.30 and purchases 2 hours additional time for space 20 getting an expiry time of 2 PM, including 30 minutes ‘free’ time left over from customer 1's transaction.

In a preferred embodiment, the length of the ID number is 8 digits as this is the minimum needed to fully encode the expiry time, space number and add a checksum to ensure the validity of any entered number.

The operation of a ticketing machine 4 is summarized as follows.

In an idle state, an LCD display on a ticketing machine 4 shows “ENTER SPACE” and shows current clock time and date as existing system. In this state, bank note and card payment are disabled but coin payment is enabled.

To purchase time for a parking space, the following steps are performed starting with a user inputting to the machine 4 via a keypad or the like a number identifying the relevant parking space:
(a) User types in space number.
(b) Notes and card payment are ENABLED as soon as a valid space number is keyed in.
(c) User inserts card first, blocks coins and notes payment. OR
   User inserts coins or notes first, blocks card payment.
(d) User continues to insert coins, notes, or follows prescribed card steps until required expiry time is purchased.
(e) User pushes BUY button.
(f) Machine updates card or puts coins into coinbox, notes are already in box.
(g) Machine stores updated space information.
(h) Machine Logs transaction.
(j) Space is marked as purchased and available for broadcast to web server 5. If this space was already marked as ready for broadcast it will set a new flag “MultipleSales” to indicate that the space was sold more than once since the last time it told the PC.
(k) Machine prints space ticket with ID, if configured.
(l) Machine back to idle, User can start again.
   To purchase additional time for a parking space using the ‘Add’ function or to add new credit to a pre payment card, the following steps are performed:
(a) User pushes BUY button on ticketing machine 4 to initiate the Add operation.
   Machine starts Add mode.
   If cards are available for recharge Display shows:
      “Enter ID or Insert card”,
   If cards are not available for recharge Display shows:
      “Enter ID”
   If the ID number is entered, the Machine prompts the user to enter the relevant space number. The machine then validates the ID number in the following way. First, the expiry date and time is decoded and must be found to be in the future, within a pre-determined maximum fixed period. Second, the space number is decoded and compared to the entered space number, which it must match. If these two requirements are met the ID number is validated. In a preferred embodiment a third requirement must be met for the ID to be validated. In this embodiment the ID also encodes a company installation number that is unique to the company operating the parking area. The ticket machine decodes this installation number from the ID code and compares it the corresponding installation number configured in the machine. The two must match for the ID code to be validated. This step prevents ID numbers issued by ticket machines at a parking area operated by a first company (having a first company installation number), being transferred for use at identical model ticket machines at a parking area operated by a second different company (hence having a second different company installation number).
(b) If the 8 digit ID from the ticket is validated, then the machine operates in accordance with steps (b) to (1) outlined above in the previous section to allow the additional time to be purchased OR
   If a prepayment card is inserted, the machine enters Recharge card operation, whereby a user can inset bank notes or coins into the machine to credit payment to the card in a known way.
      Preferably, the ticket machines 4 are configurable so that the ‘ADD’ function can be selectively enabled and disabled by the system's operator, either locally at each machine or remotely over the network 7. In this way the operator can select whether or not the ticket machines 4 are to provide this function.

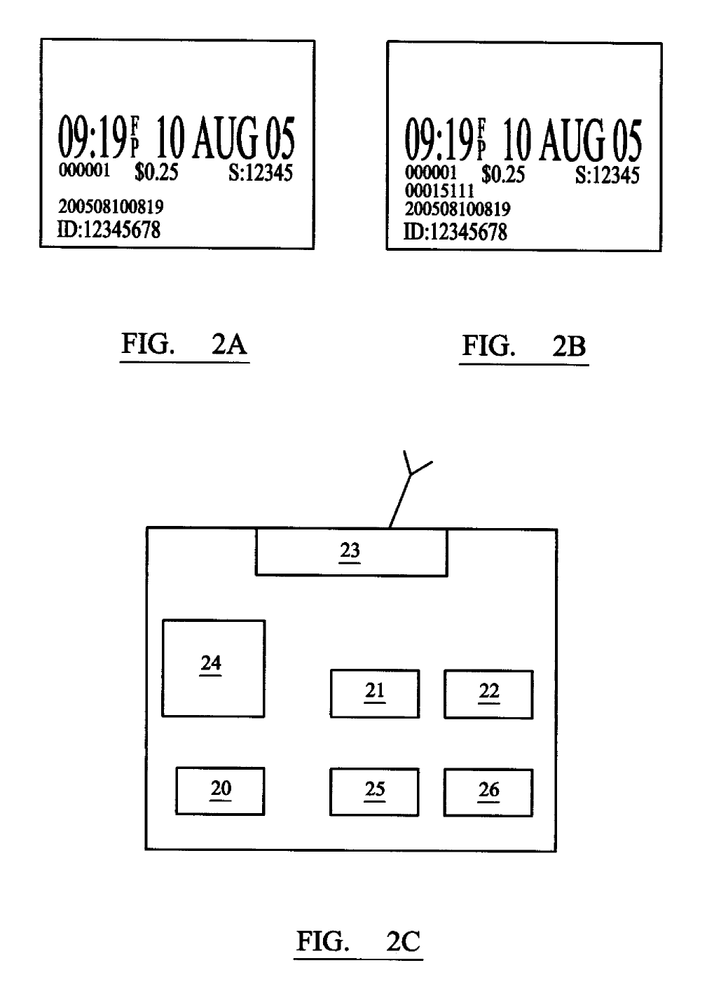

FIGS. 2a and 2b each illustrate formats for a ticket receipt issued by the ticketing machines 4. The format illustrated in FIG. 2a is for purchases made with bank notes or coins and that in FIG. 2b is for purchases made with pre payment cards. The formats are identical except that the in prepayment card format the serial number of the card is printed onto the receipt.

The data shown on tickets is summarized as follows:
09:19 am 10 AUG 07—Ticket expiry date and time
000001—Machine number
$0.25—Money paid or taken from card
00015111—Card serial number if ticket purchased with card (will be blank if ticket purchased with cash/notes)
200508100819—Ticket valid from time, either purchase time or period when car park open if ticket purchased in advance
ID:12345678—ID for adding time to space
   “ID” is from language file
   “:” is added by machine
   “12345678”-8 digit ID generated by machine
S:12345—Space Number
   “S” is from language file
   “:”is added by machine
   “12345”-5 digit (4 initially) space number entered by user and validated by machine.

The ticketing machines 4 are configured to contact the server 5 every “BroadcastPeriod” minutes, with no immediate retries if no connection is made. Even if there are no sold spaces to report, each machine is configured to contact the server 5 in this way as a ‘heartbeat’ signal to indicate to the server that the machine is functioning and able to communicate.

The ‘broadcastperiod’ is configurable and may be set as a value in minutes, for example 0=disabled, 1=1 minute, 2=2 minutes depending upon user requirements. At the end of each ‘broadcast period’ each ticketing machine 4 contacts the server 5 to report 0 or more transactions.

Alternatively, the ticketing machines 4 may be configured to transmit the information to the web server 5 immediately after each transaction is completed. In this configuration, the broadcastperiod can still be used to send the ‘heartbeat’ signal to the server 5 when no spaces are sold.

Each ticket machine 4 sets and logs a new status event “General Error: GPRS Failed” in the event that use of the GPRS connection fails, and subsequently resets and logs this event if use of the GPRS connection then works. If the BroadcastPeriod is 0 (disabled) a machine 4 will log an immediate toggle of this event, i.e. ON/OFF so that it appears in the log. This is necessary because the machine 4 will not know when the next communication will take place and so it will log the event and revert to good status immediately after this. With the BroadcastPeriod set (normal space operation) the event will remain set until the next good communication takes place.

GPRS connection failure may trigger an orange (amber) warning lamp on the machine 4.

FIG. 2c is block diagram illustrating components of a ticketing machine 4. The ticketing machine comprises data input means 20, for example a keypad, for users to input data, including space numbers and ID numbers, to the machine. The ticketing machine 4 further comprises control circuitry 21 for controlling the functioning of the machine including the generation and validation of ID numbers, a memory 22 for storing information and a communications interface 23 for communicating via the network 7. The ticketing machine 4 is also provided with a display 24 for displaying information to users, a printer 25 for printing tickets, and a payment system 26 for users to purchase parking time using money (coins or notes) or cards.

### Enforcement Using the Portable Monitors

One or more parking attendants control payment enforcement, each using a portable terminal 9. The web application provides an easy to use interface allowing an attendant to select the required parking areas and data view on a display of a portable terminal 9. Data may be viewed as a list view or as a map view, as will be explained below.

In general, parking staff are interested in spaces which have recently expired or are unoccupied but have a vehicle parked in, therefore the key data transmitted from the server 5 to the portable terminal 9 is:
Space number
Time remaining for space
Current status (unoccupied, occupied, recently expired)
Machine communication status (i.e. Status to show if any machines have failed to communicate within the anticipated period)

A facility to print the current space information can be made available for manual use as a backup, users would be required to use the application on a computer attached to a local printer.

In one embodiment, spaces and their status are displayed on the terminal's 9 display in a list and are grouped according to whether they are paid for (occupied), not paid for (unoccupied) or recently expired. Features of the list are summarized as follows:
Each parking group is sorted in numerical order of space numbers.
Spaces in each section within the offset of the expiry time are shown by color.
The expiry time/date is updated continuously.
The records will change sections if their status changes, i.e. they have time bought or they become expired due to the passage of time.

Preferably, an attendant is able to tick/mark a space that needs double checking later, for example a space occupied but not paid for or near to expiry. This facility would help enforcement in situations where the car park operator offered a grace period from the actual parking time in which users can get change and purchase a ticket. Ticked spaces may be un-ticked after an enforcement check has been completed.

In another embodiment, spaces and their status are displayed on the terminal's 9 display in a map format, for example, a bit map picture illustrating a schematic of a layout of the parking area. The maps may be imported bit maps having a fixed scale for the display screen in use or, may be configurable within the system. Features of a preferred map display are summarized as follows:
Whether a space is paid for or not is shown by color.
When the attendant hovers a stylus over a displayed space, the expiry time/date will show. The expiry time/date will be updated continuously.
The color of a space will change if the space changes status, i.e. they have time bought or they become expired due to the passage of time.
An attendant is able to tick/mark a space that needs double checking later-occupied but not paid for or near to expiry and to un-tick all spaces after an enforcement check

### System Start-Up, Configuration and Usage

The following section describes in more detail functionality provided by the web server 5 and database 6, which as mentioned above can be accessed using standard Internet browsers meaning that no specific software installation is required on the terminal 8 or the portable terminal 9. FIGS. 3 to 43 show schematics of browser windows. Copyright may subsist in the design of the browser windows and is not waived by virtue of the inclusion of the schematics in the present application.

### System Start-Up

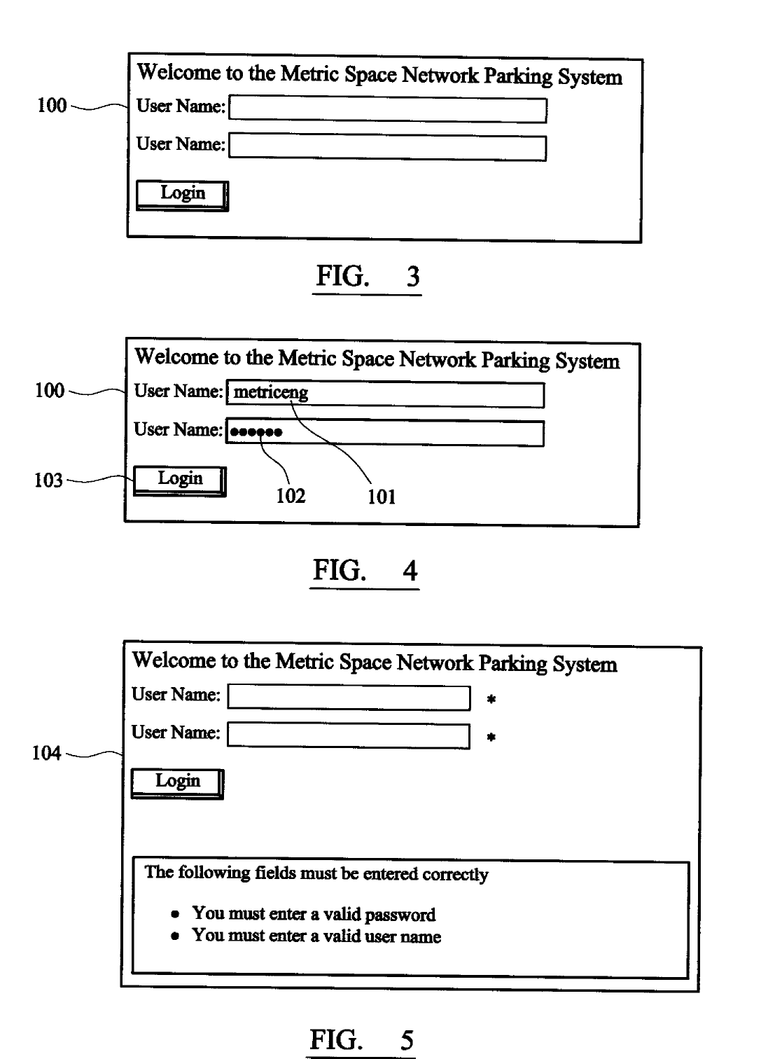

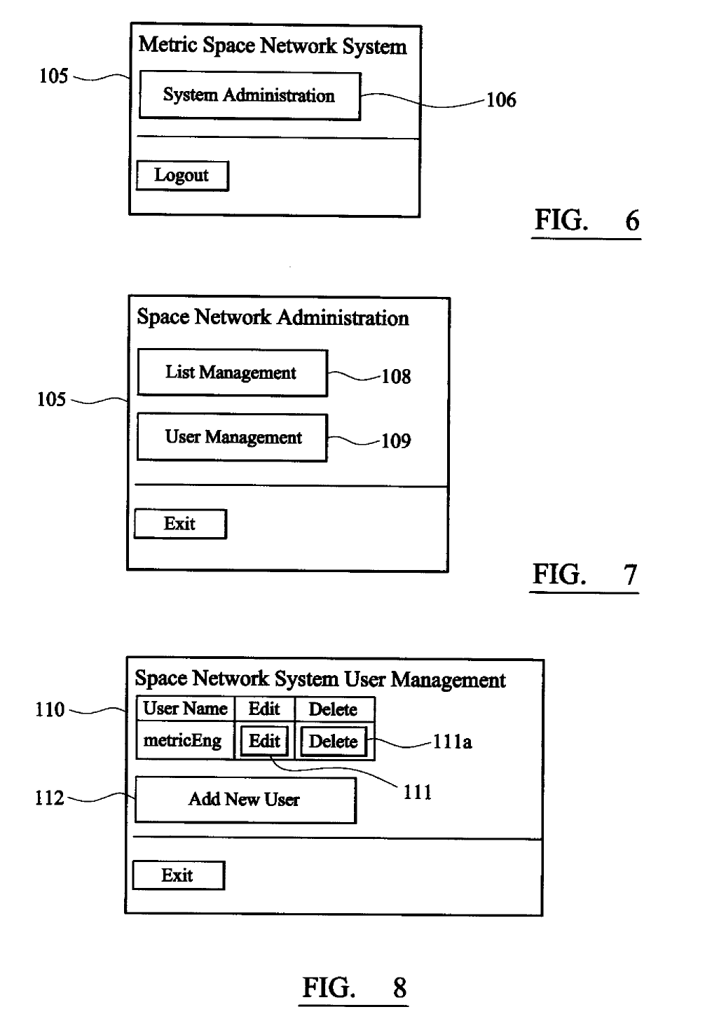

A user of a terminal, say terminal 8 or terminal 9 accesses the web server 5 by running the browser and specifying a URL such as ‘http://localhost/Metric_Spacesystem’ to display an initial login page 100, FIG. 3. The initial login page 100 allows access to the system and the first time the system is accessed only one account is valid for use. To access this account a user inputs a supplied user name 101 and password 102 and clicks a login button 103, FIG. 4.

The initial account can be renamed and its password changed at this stage to enhance security, but, if all accounts are inadvertently deleted, the next time the system is started the initial account will be recreated with the default password and privileges. The initial account has administrator rights which are needed to create new logon accounts.

The User Name and Password are required fields and neither can be left blank, if this is done, the error page 104 is presented to the user in response to clicking the Login button, FIG. 5. If login is successful, the main System page 105 is displayed, with the System Administration function being the only function available with the initial logon, FIG. 6.

Clicking on the System Administration button 106 will cause the Space System Administration page 107 to be displayed, FIG. 7. The Space System Administration page 107 has 2 buttons, a List Management button 108, used to manage the various lists held within the System, and a User Management button 109, used to manage user logon accounts.

Clicking on the User Management button 109 will open the Management page 110, FIG. 8. This screen 110 provides for the addition, deletion and editing of user accounts. Initially, the only account that will be listed is the initial account, as stated earlier. This account can be edited by clicking on the edit button 111.

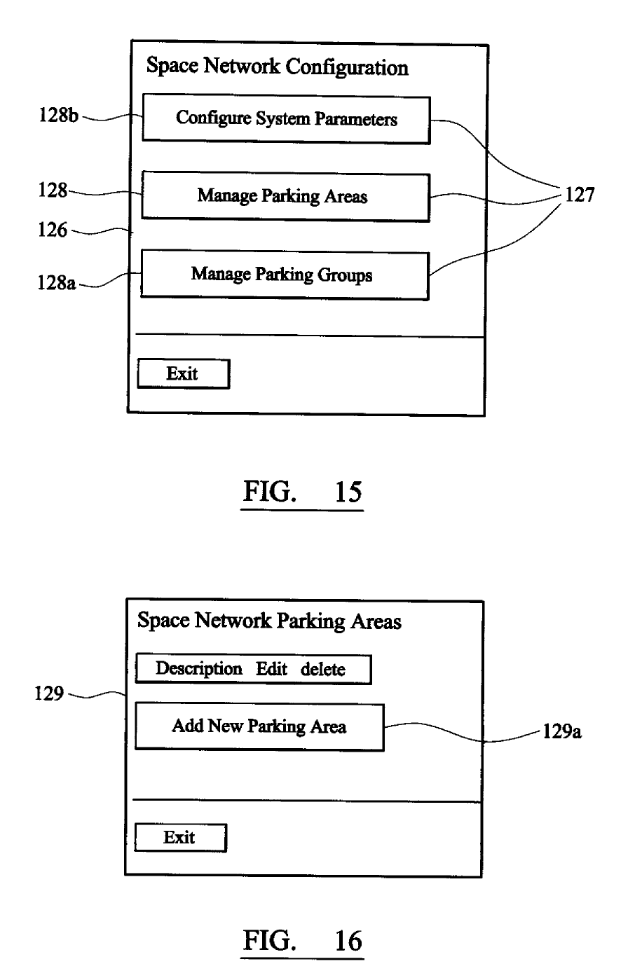

A new user can be added to the System by clicking on the Add New User button 112 which will open the User Details page 113, FIG. 8. Completing the user name field 114, password field 115, confirming the password field 116, then clicking Update User Details 117, will create, in this example, an account called j.blogs having the appropriate password, FIG. 10.

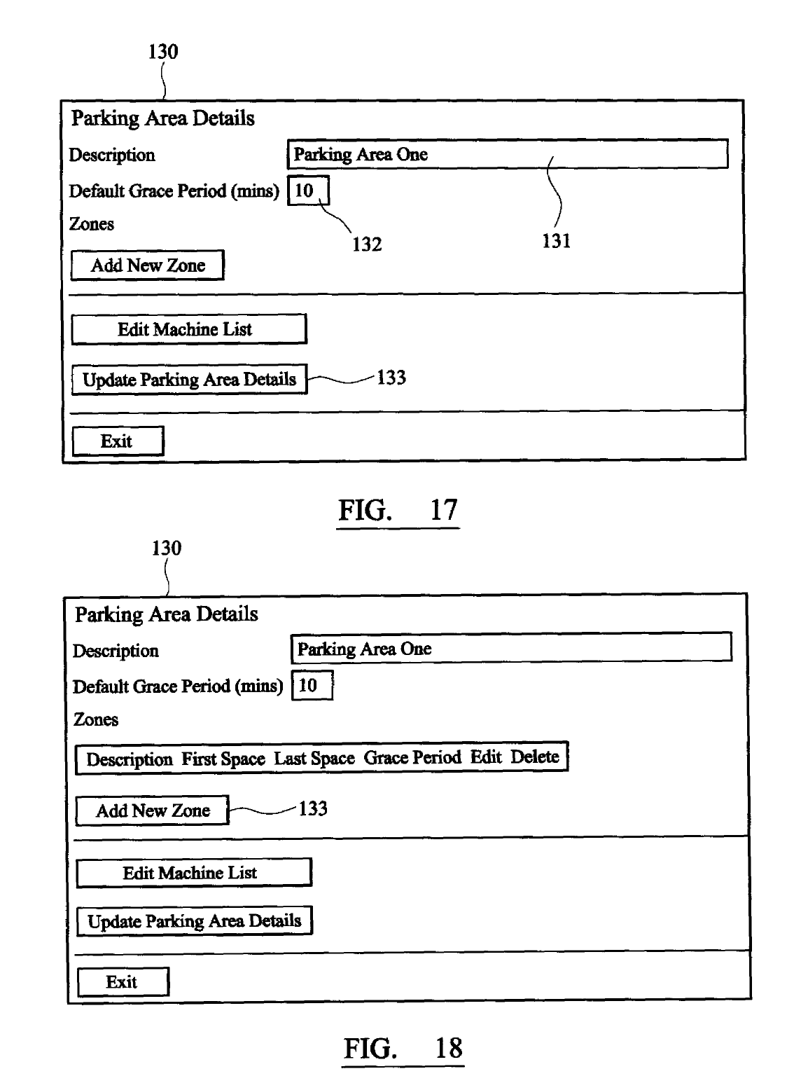

Once the user details have been updated the page 113 will update, the password fields 115, 116 will clear and an Update Completed statement 118 will pop-up at the bottom of the page, FIG. 11. User roles may now be assigned to the account.

Clicking on the Assign Roles To User button 119, will open the Roles Assigned to User page 120, FIG. 12.

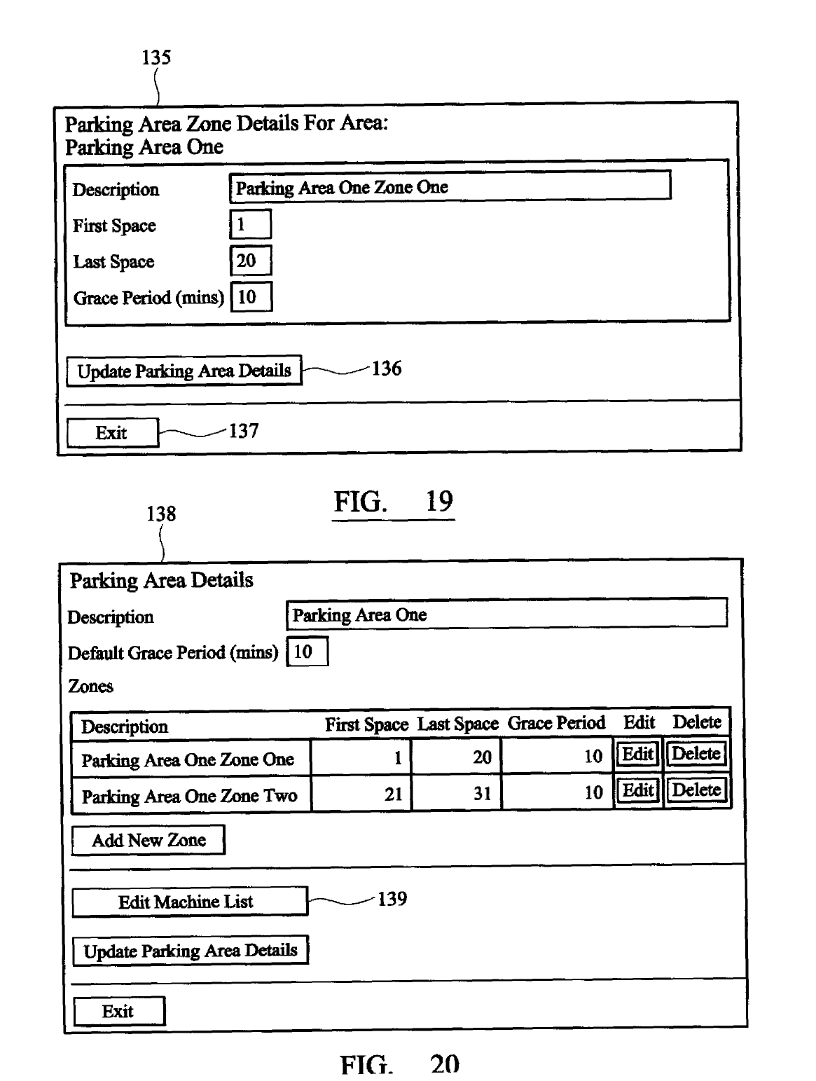

By highlighting selected available roles displayed in a menu 121 and then clicking on the ADD button 122 roles can be assigned to the user, FIG. 13. At this stage an update button 123 is to be clicked. Clicking the Exit button 124 returns the previous screen.

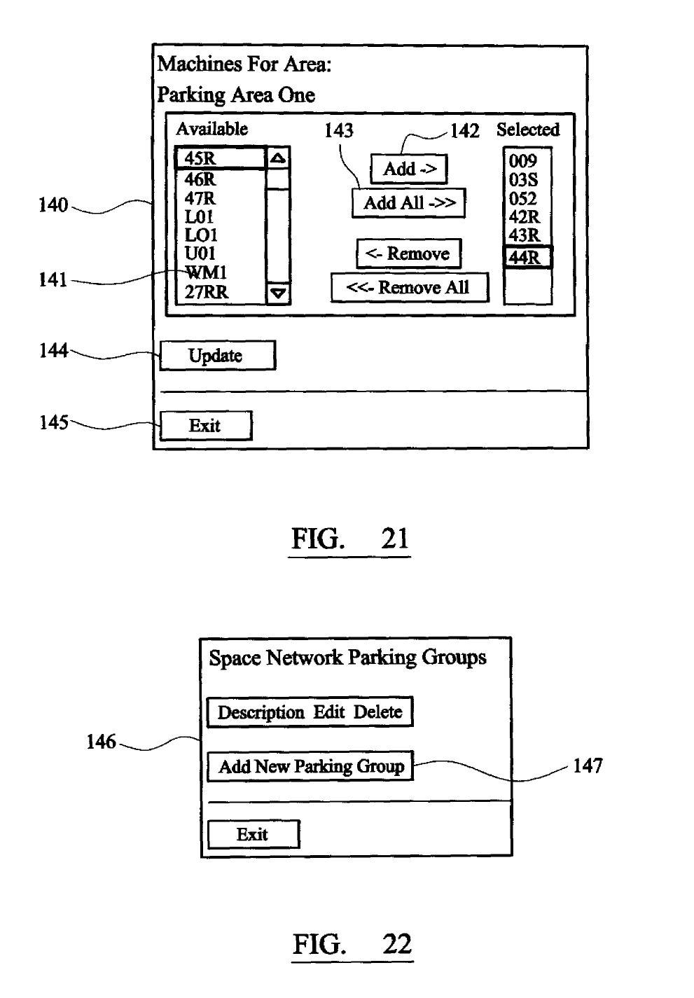

Multiple roles can be assigned to a user account giving that account a large role within the system, as illustrated in FIG. 14, which shows a page 125 of an account to which all roles have been assigned.

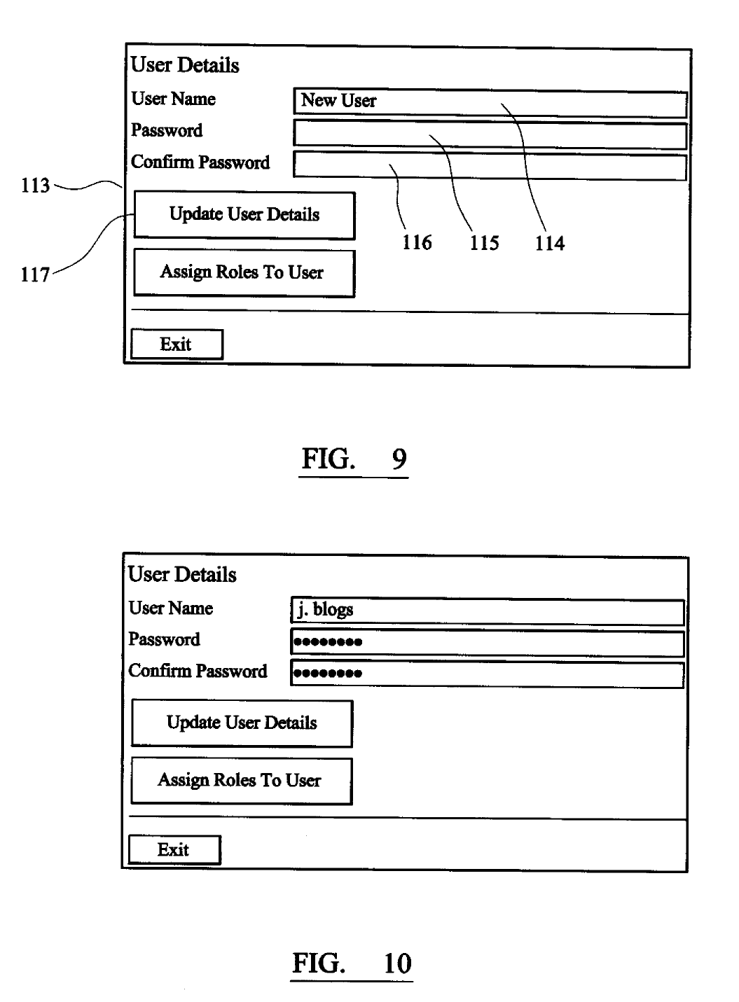

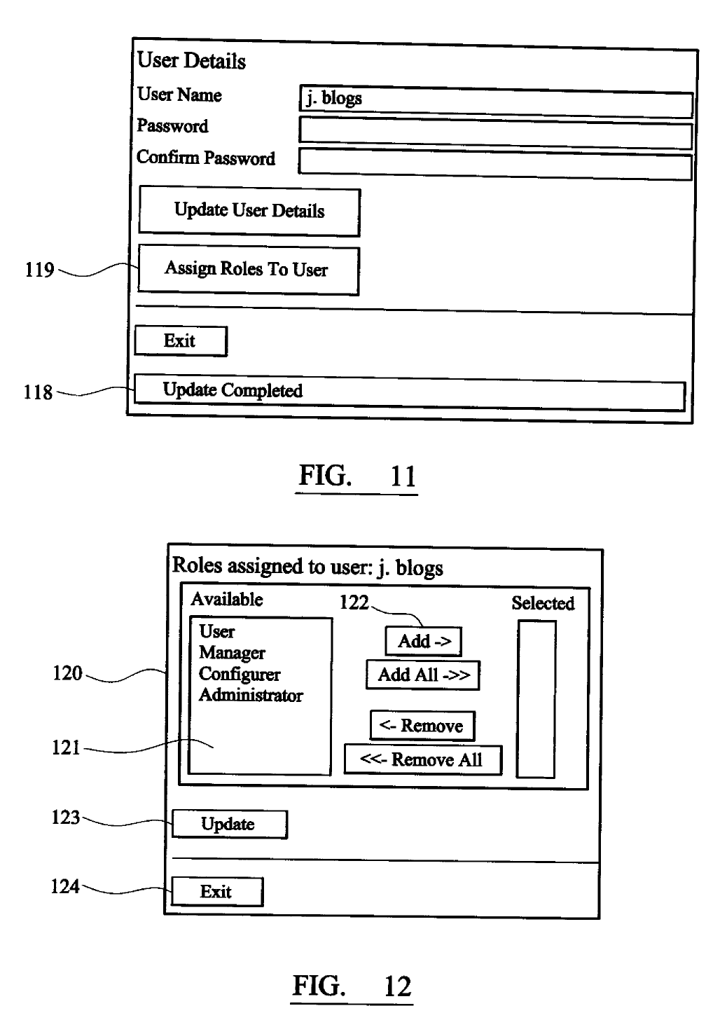

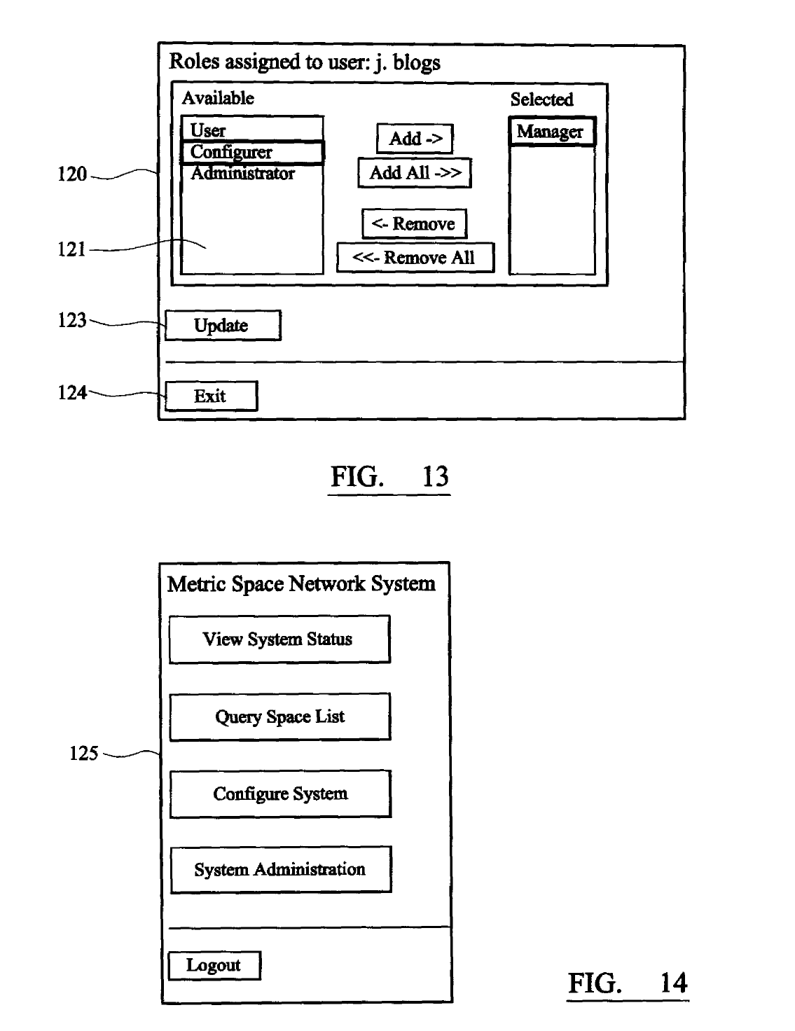

An existing account can be edited from the Management page 110, FIG. 8, by clicking on the edit button 111 of the account to be edited. This displays the User Details page 113, FIG. 9, from which passwords, logon details and roles can all be changed. An account can de deleted, by clicking on the Delete key 111a of the Management page 110, FIG. 8.

### System Configuration.

A user having the appropriate rights and privileges to configure the system can do so by accessing the Configuration page 126 illustrated in FIG. 15. This page 126 enables the user to configure the system parameters, parking areas and the parking groups by clicking on one of the options 127 displayed on the page 126.

To configure the system the following steps may be applied:
First define the Parking Areas
Next define the Parking Zones
Add the machines to the appropriate Zones
Next Add the Parking Groups
Finally add the Parking Areas to the Parking Groups
Configure System Parameters

A Parking Area is a collection of spaces (organized into Zones) and typically represents an individual car park or group of on street spaces. Parking Areas are contained within parking groups in the system's hierarchy and may exist in more than one group. The main purpose of Parking Areas is to group together a collection of spaces for presentation purposes as this allows enforcement to be carried out by viewing an organized collection of spaces (e.g. an individual car park).

Clicking on the Manage Parking Areas button 128 on the Configuration page 126 opens the Parking Areas page 129, FIG. 16. Clicking on the Add New Parking Area button 129a opens a Parking Areas Details page 130, FIG. 17. The user can enter a description of the parking area to be added in window 131, and change a default grace period by entering a time into window 132.

The grace period is the over run time a customer is allowed before their space is reported as out of time. The default period is 10 minutes and this in effect gives a person purchasing 30 mins of parking 40 mins before the system reports it to the attendant. The default can be set to 0 allowing no grace period.

The user updates the parking area details by clicking the button 133, causing the page 130 to change as illustrated in FIG. 18. The user can now add parking zones.

Parking Zones represent a range of spaces within a Parking Area and can only exist within one specific area. All Parking Areas must contain at least one zone. It is not possible to assign properties, for example the grace period to individual spaces only to zones, however, there is no practical limit to the number of zones that can be defined within a parking area.

Clicking on the Add New Zone button 134 in the Parking Area Details page opens a new page, the Parking Area Zone Details page 135 as illustrated in FIG. 19. This page details the description, first space number, last space number, and the grace period in minutes, which will apply to this zone.

Once a user has entered appropriate details for the zone into the page 135, the Update Zone Details button 136 is to be clicked. Then clicking on the exit button 137 displays an updated Parking Area Zone Details page 138, FIG. 20 enabling the user to add additional zones or to edit the newly created zone. In this example, two zones have been added Parking Area One Zone One with spaces 1 to 20 and Parking Area One Zone Two with spaces 21 to 31.

Once a user has entered all the zones, ticket machines need be added to the parking area. This is achieved by clicking on the Edit Machine List button 139 to open the Machines For Area dialogue page 140, FIG. 21 to add machines to the parking area.

Although ticket machines can only physically exist in a single location they can be assigned in the system to more than one Parking Area. This rule allows a machine to be located outside of a car park (e.g. within a shopping mall) and to allow purchases of spaces from more than one car park from the same machine. In order to be able to identify the space being bought all areas that a machine is allocated to must contain uniquely numbered spaces.

Machines can simply be added to the area(s) using the Machines for Area dialogue page 140 by selecting any of the machines identified in the list 141 and clicking the Add button 142, or selecting all the machines in the list 141 by clicking the Add All button 143. Once all the required machines have been added to the area the Update button 144 is clicked and then the exit button 145.

Parking Groups are the top level container in the system and comprise a list of Parking Areas. The main purpose of Parking Groups is to allow a collection of Parking Areas to be grouped for presentation purposes. The Parking Areas within Parking Groups can have non unique space numbers if required.

Clicking on the Manage Parking Groups button 128a on the Configuration page 126, FIG. 15 opens the Space Networks Parking Groups page 146, FIG. 22. Clicking on the Add New Parking Group button 147, opens a Parking Group Details page 148, FIG. 23. After completing the Description field 149 the user clicks on the Update Group Details button 150 to update the page and to activate the Add or Remove Areas button 151.

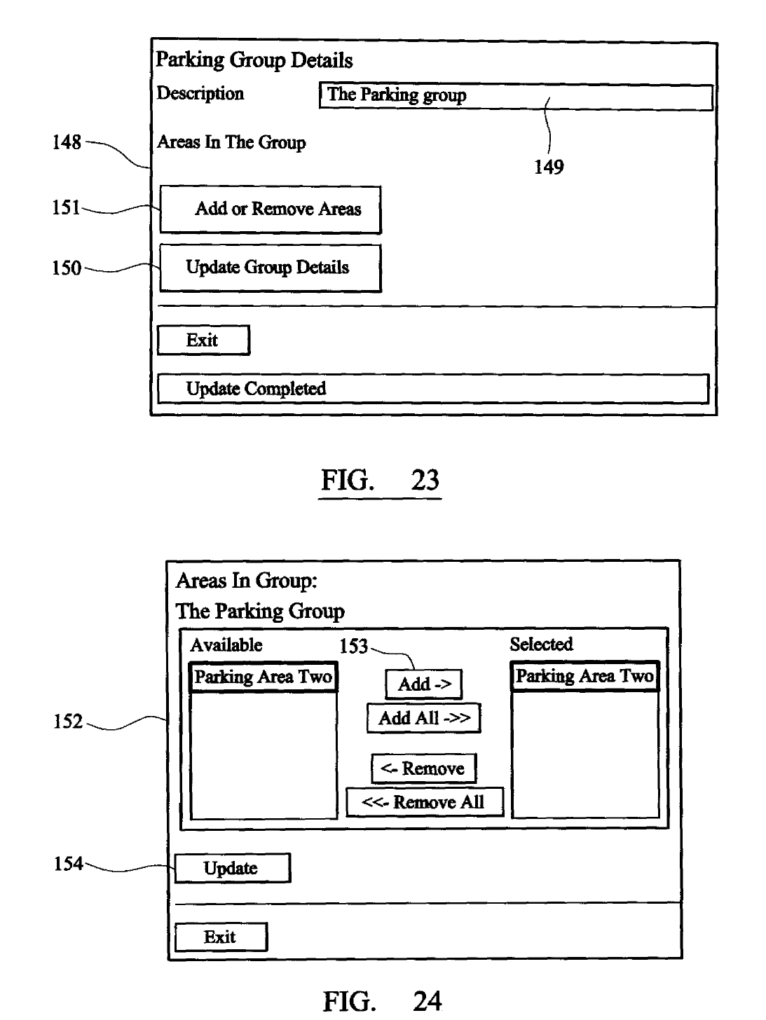

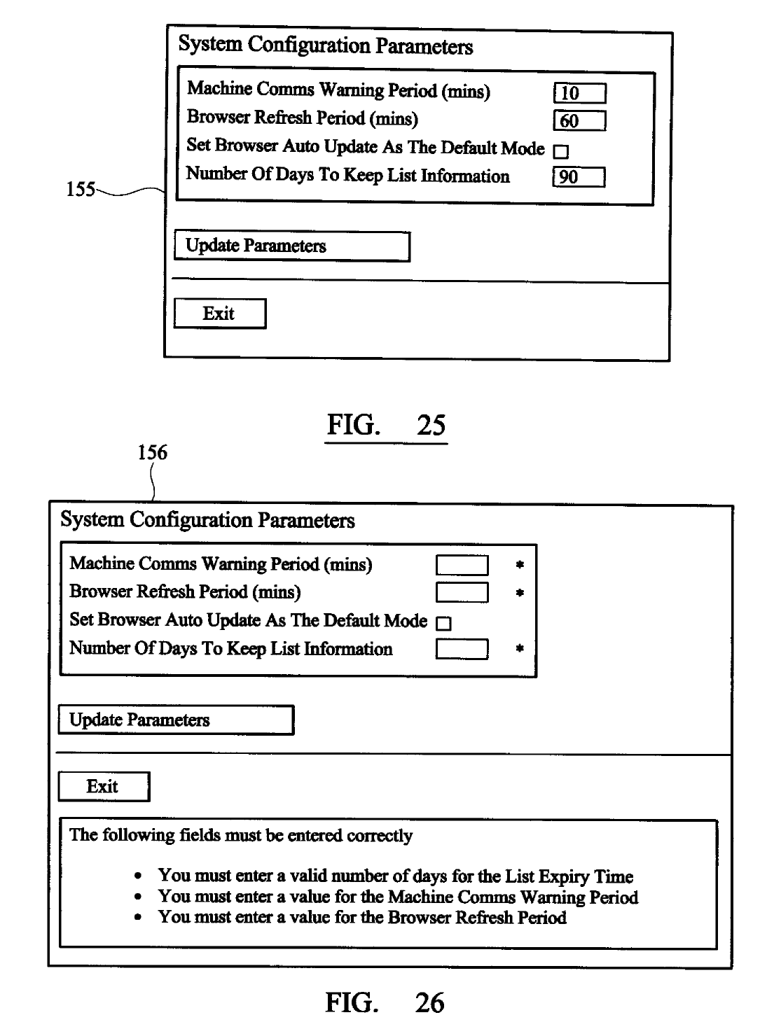

Clicking on the Add or Remove Areas button 151 opens the Areas in Group dialogue page 152, FIG. 24, allowing a user to select available parking areas to put in this group by clicking the Add button 153. Multiple areas can be placed in the same group. Once finished the Update button 154 is to be clicked.

Clicking on the configure system parameters button 128b on the Configuration page 126, see FIG. 15 opens the system configuration parameters page 155, FIG. 25.

The system parameters that a user can configure using this page are defined as follows:
Machine Comms Warning Period is the grace period time set in system before it flags to the user that a ticketing machine has not communicated.
Browser Refresh Period is the interval period between browser refreshes.
Set Browser Auto Update as the Default Mode is to be ticked if it is required that the browser auto updates as the default.
Number of Days to Keep List Information is the number of days the space use information will be kept in the system for querying before it is deleted, preferably automatically deleted by the system.

### Typical default values for these fields are as displayed in FIG. 25.

The Machine Comms Warning Period, Browser Refresh Period and Number of days to keep list information are required fields. If an attempt is made to update these parameters where these details have not been entered the error page 156 shown in FIG. 26 is displayed.

### System Usage

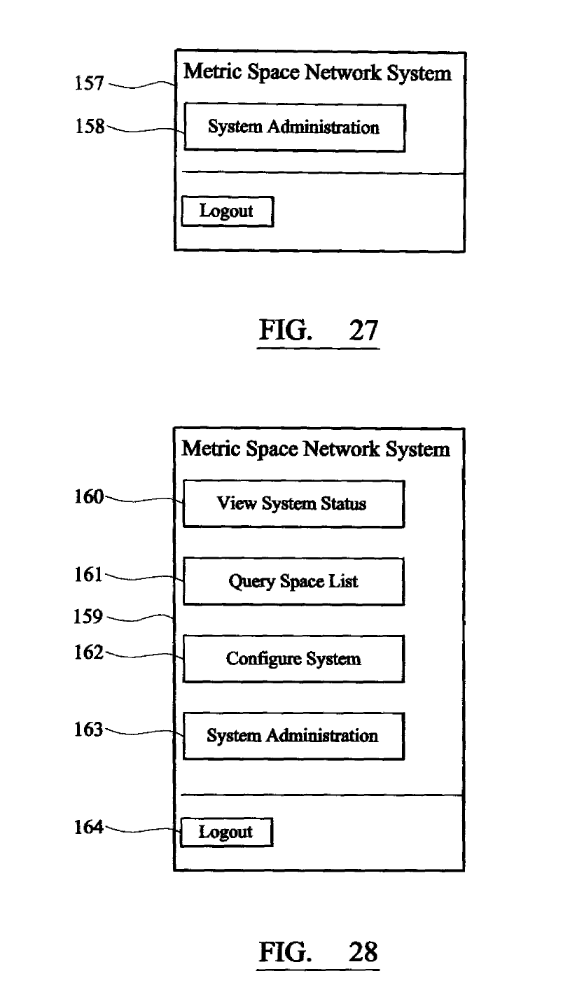

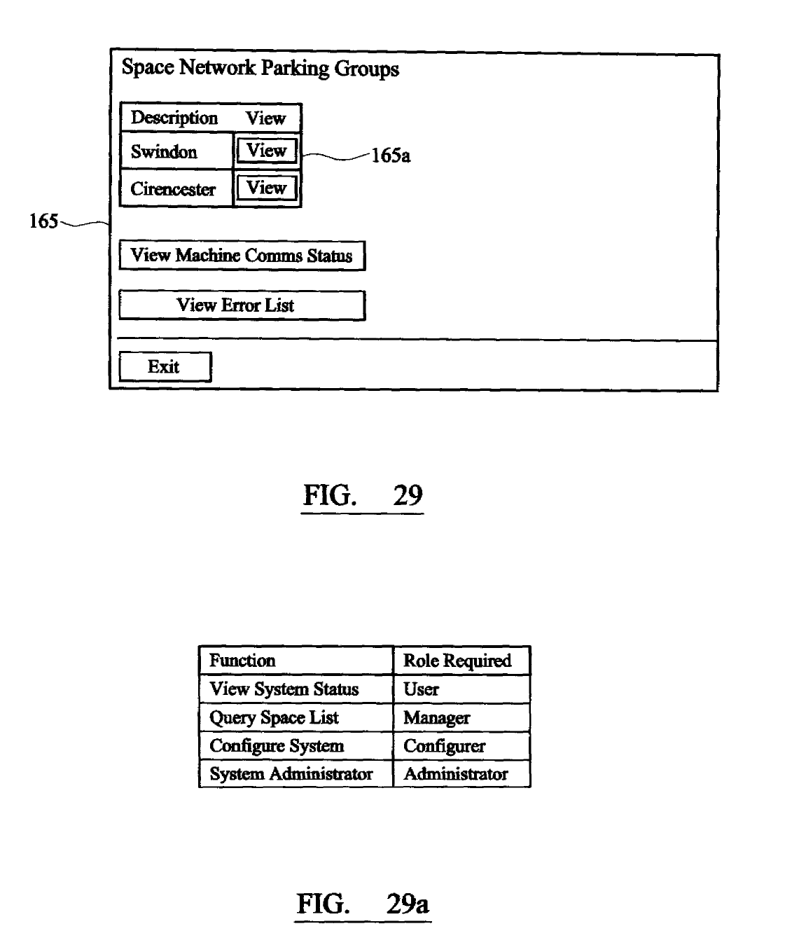

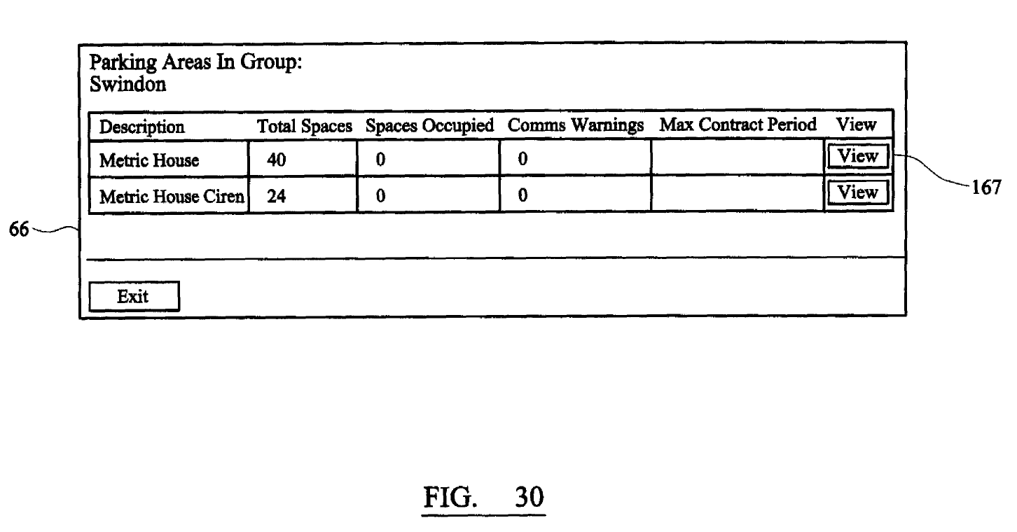

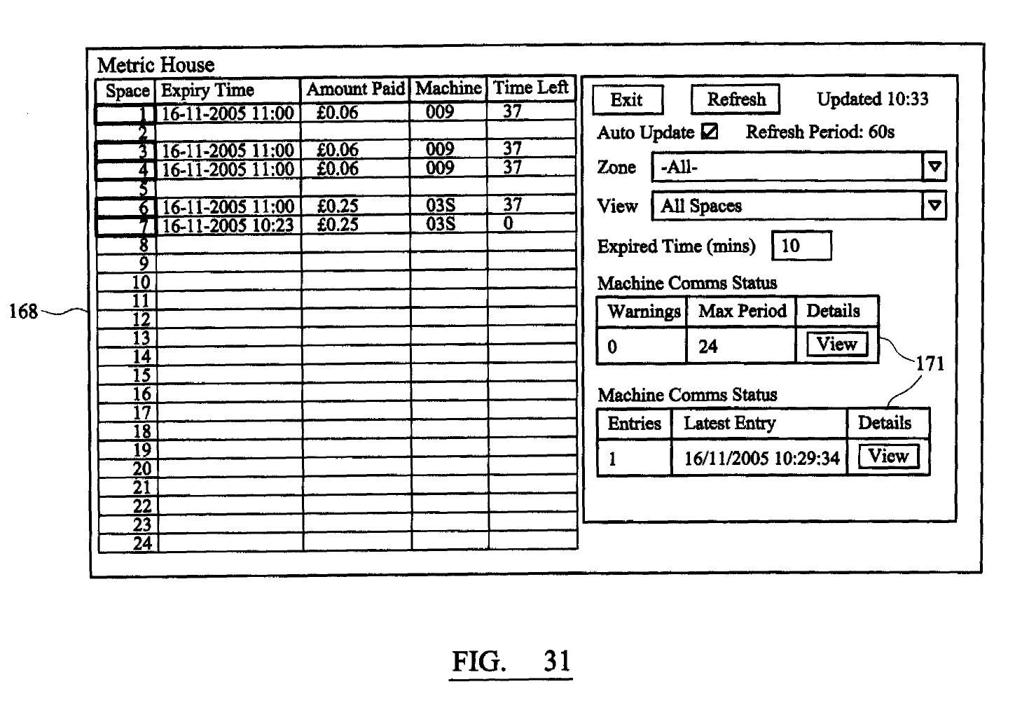

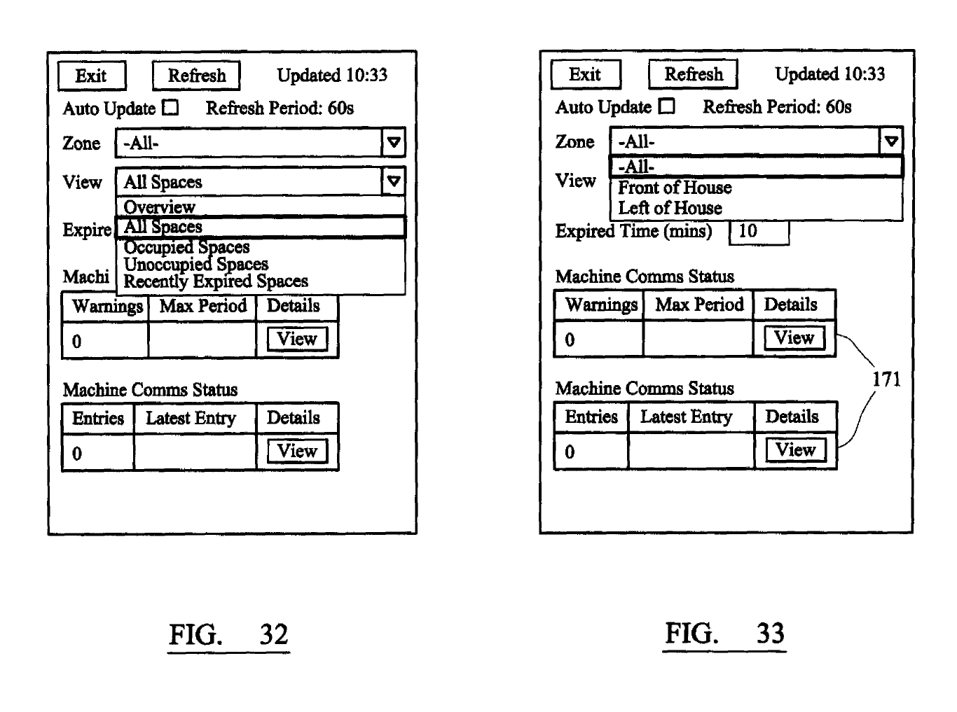

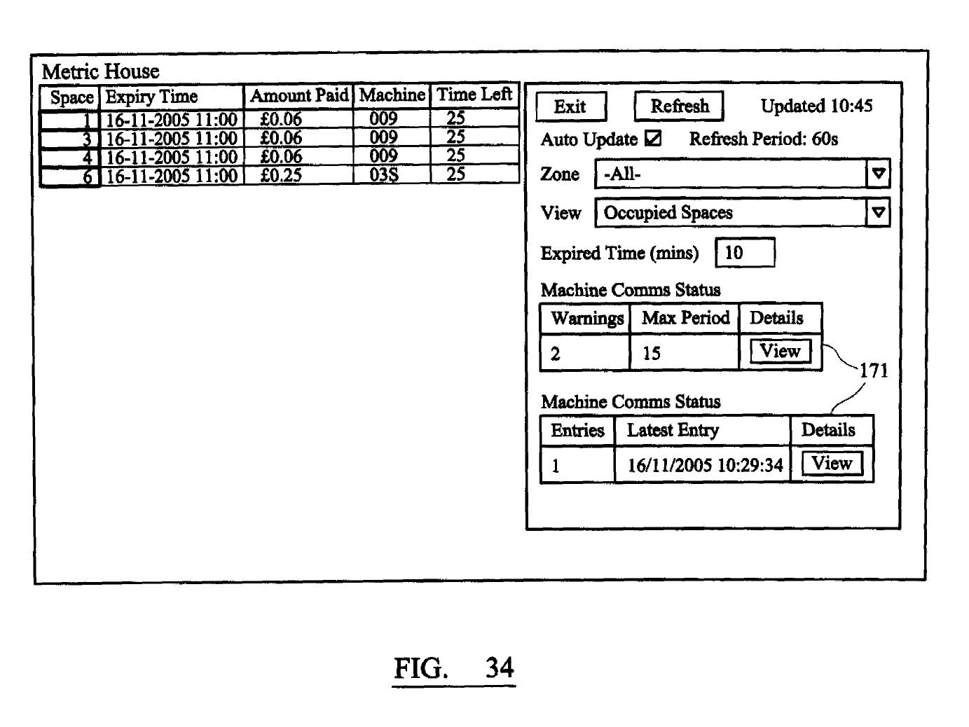

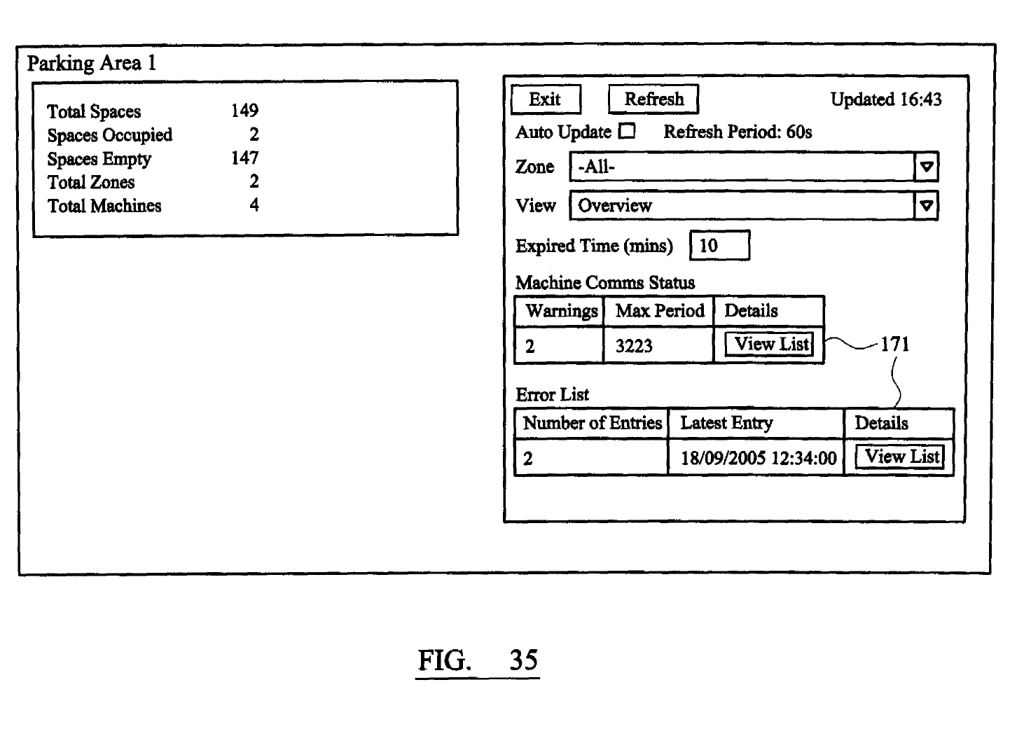

After a successful login as administrator, the Main Page 157 is displayed with the System Administration option available, FIG. 27. Clicking on the System Administration button 158 will display a page 159, FIG. 28 showing the functions available to the logged on user. The functions available to a particular user will depend upon the roles assigned to that user by the system administrator, see FIG. 29a. Multiple roles can be assigned to a single logon account, giving a large role to the logged on account. In the example illustrated in FIG. 28, the logged on account has been given all roles, allowing the logged on user to do all operations in the Space Network System.

Referring to FIG. 28, the view system status button 160 provides access to enforcement information screens that provide details of the currently paid for spaces and the status of all machines that are allocated to each Parking Area. The query space button 161 provides access to a list query facility that is used to provide additional information to help in resolving disputes. The configure system button 162 provides access to the system configuration options. The system administration button 163 provides access to the system administration options. The logout button 164 logs the current user off the system.

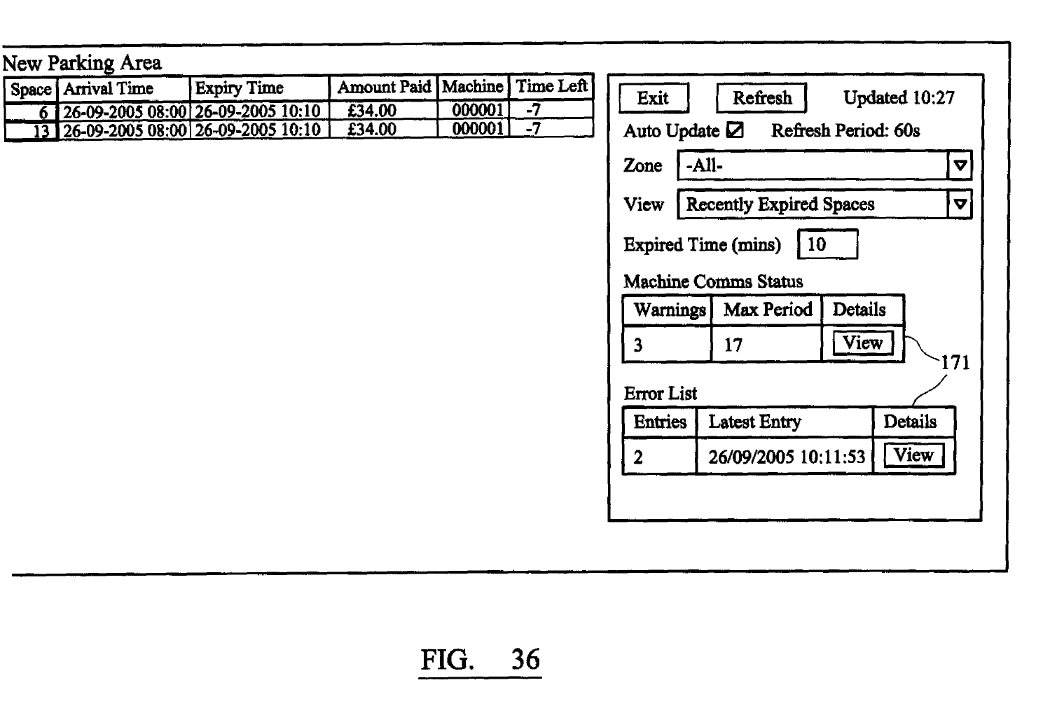

Clicking the view system status button 160, displays the Parking Groups Viewer page 165, FIG. 29. As previously mentioned, the main purpose of Parking Groups is to allow a collection of Parking Areas to be grouped for presentation purposes. The Parking Areas within Parking Groups can have non unique space numbers if required. A user can select a parking group to view, in this example say ‘Swindon’, by clicking on an appropriate view button 165a, in the Parking Groups Viewer page 165. This displays a parking areas page 166, FIG. 30, showing the areas allocated to the selected group.

A user can select a parking area to view, in the example ‘metric house’ by clicking on an appropriate view button 167, in the parking areas page 166. This displays a parking areas space page 168, FIG. 31.

The parking areas space page 168 displays details for all spaces in the selected parking area. The parking areas space page 168 is designed to give the user at a glance the space usage and any system information they might require.

The space use information displayed in this page 168 is summarized as follows:
Space: Space number allocated to the parking space. The space can be highlighted in either green time remaining on the space or purple if the space has expired, or blank if no time is currently purchased for the space.
Expiry time: The time the space will expire
Amount Paid: The amount paid, if the amount is preceded by a ‘+’ symbol then this indicates a add mode ticket purchase.
Machine: The machine where the space was bought
Time Left: Time remaining before the space will expire, this will include any grace period allowed, any expired spaces will have the time displayed preceded by a ‘−’ sign.

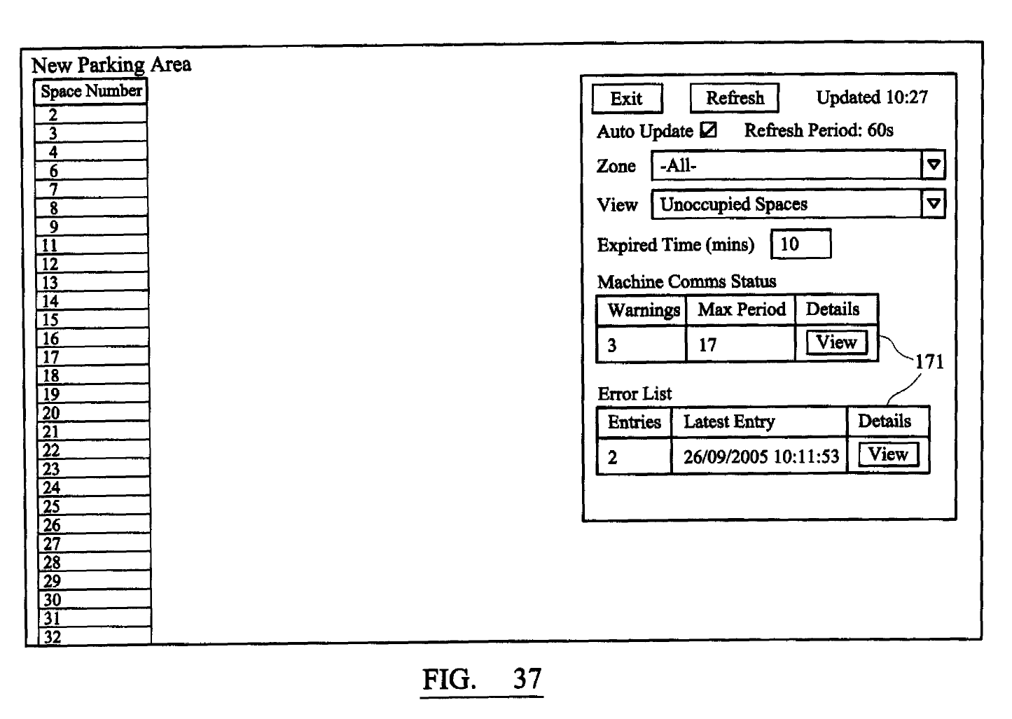

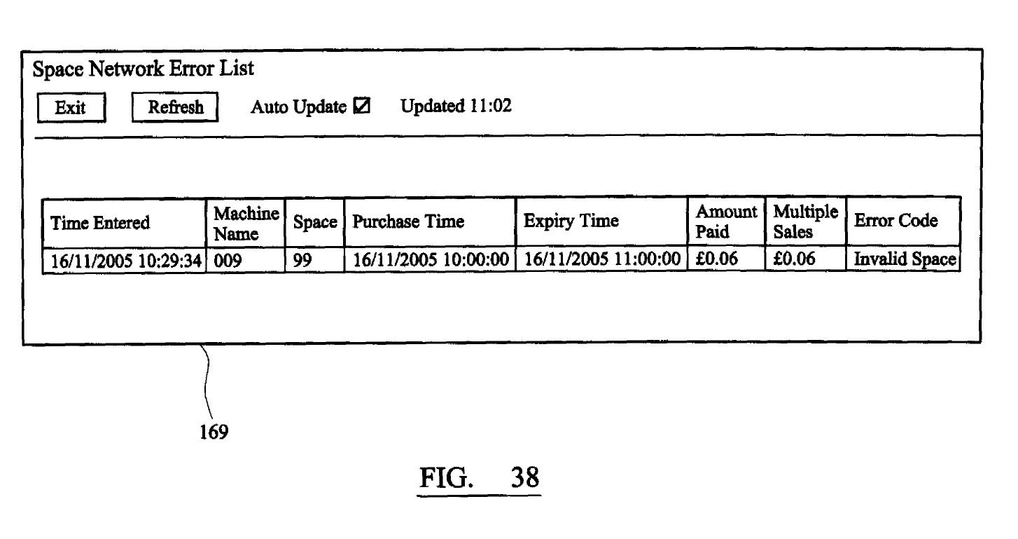

### The zone and space information viewed can be changed if required by using the drop down boxes at the right hand side of the page 168, as shown in more detail in FIGS. 32 and 33.

By selecting List Occupied Spaces from the drop down box in the view field, the view changes to listing only those spaces which are occupied, FIG. 34.

By selecting Overview from the drop down list in the view field the table at FIG. 35 is produced giving an overview of the area selected. In this example, the area contains 4 machines in 2 zones Out of a total of 149 spaces 2 are occupied and 147 are empty.

By selecting Recently Expired Spaces from the drop down list in the view field the table at FIG. 36 is produced listing recently expired spaces only.

By selecting Unoccupied Spaces from the drop down list in the view field the table at FIG. 37 is produced listing all Unoccupied Spaces only.

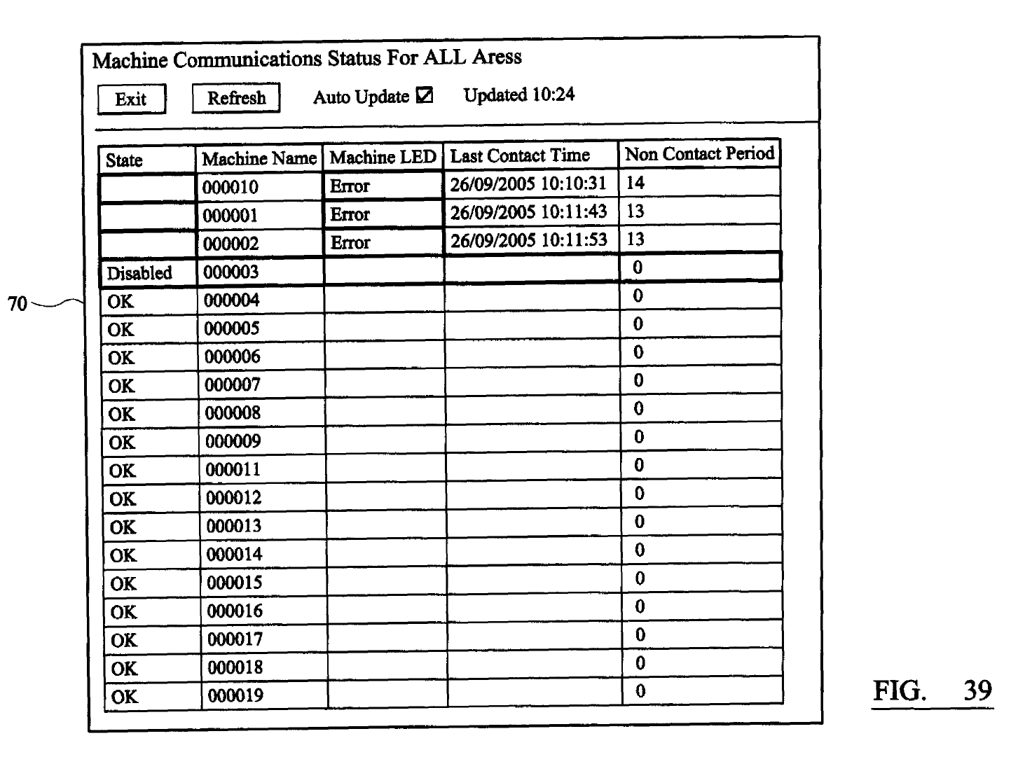

The parking area space page 168 also gives the user the option to select and view an Error List 169, FIG. 38 and a Machine Comms Status page 170, FIG. 39 by clicking on one of the relevant view buttons 171.

The ‘Machine Comms Status’ and ‘Error List’ may be highlighted in one color, for example red, to indicate that there are entries in the table that need investigation and highlighted in another color, for example green, to indicate that there are no entries in these tables. As illustrated in FIGS. 36 and 37, in this example, the Machine Comms Stats has 3 Warnings indicating that there are 3 machines which have errors in the comms status, and the Max Period is 17 telling the user that one of the machines in the list has not contacted the back office for 17 mins. The Error List has two entries which need investigation and the latest entry was date time stamped as at 10:11:53 on the 29-09-2005.

The error list 169 contains errors that have been identified by the server 5 that could possible need corrective action at a ticketing machine, or in the back office system.

A list of possible errors and their meanings is summarized below:
“Unknown Machine”—this error indicates that the machine name sent by the pay by space machine has not been recognized by the back office system.
“Machine Not In Any Area”—this error indicates that the machine name received by the back office system has been recognized but, it has not been allocated to a Parking Area.
“Invalid Space”—this error indicates that an invalid space number has been detected by the back office system. This is normally a configuration error where the space purchased at the machine is not contained in the back office list of spaces.
“Unknown, Code:xx”—this is a catch all error status for any unknown error codes received.

The Machine Communications Status 170 displays information about the communications between the ticket machines 4 and the server 5 relating to the purchase of spaces. In this example, Machines 000010, 000001 and 00002 have errors and have not been contacted for 13 and 14 minutes. This could indicate a possible communications problem, that would need to be investigated further.

The Query Space List is a facility that allows the space list to be queried to enable transaction information to be viewed. This information may be filtered by Purchase Time, Expiry Time, a space number, machine name, amount paid, parking area or Payment Method. The results are displayed in a table which may then be printed if required. The main purpose of this facility is to allow transactions for a specific space to be viewed in order to aid in resolving disputes.

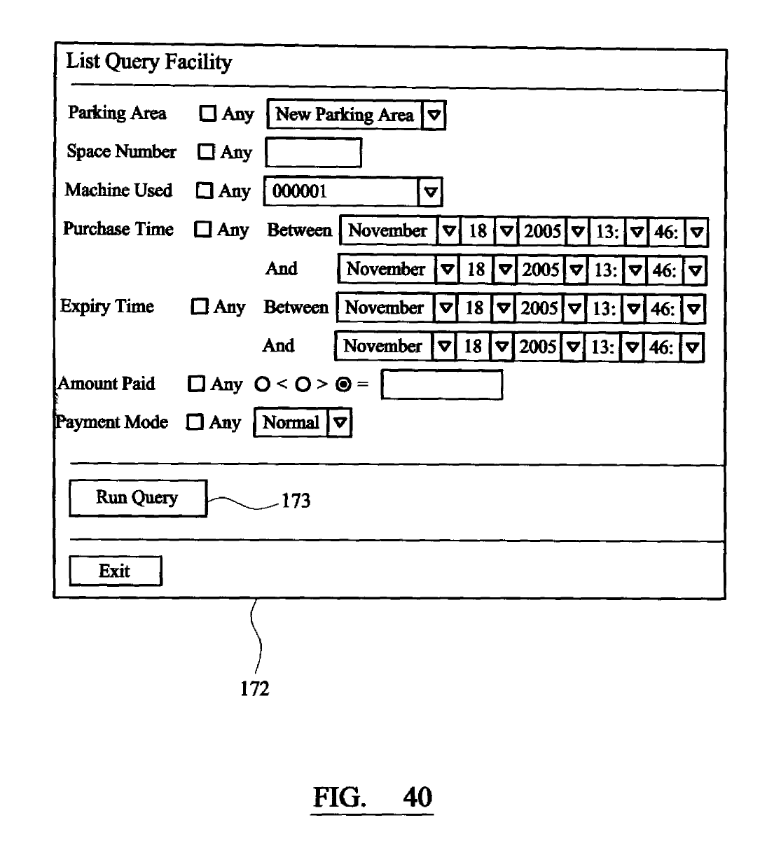

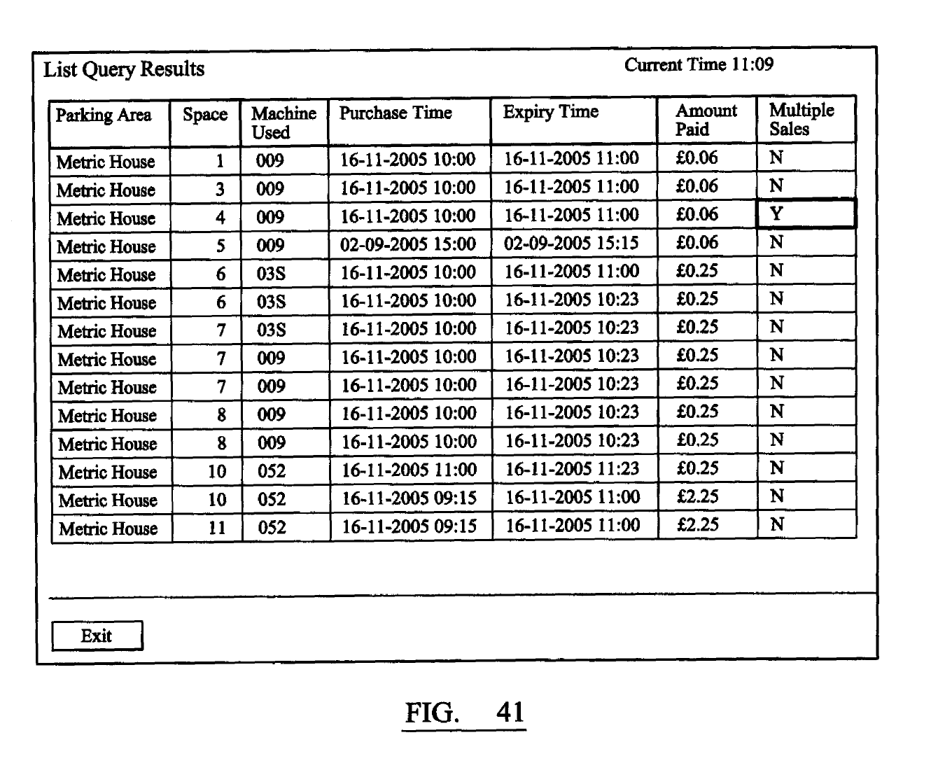

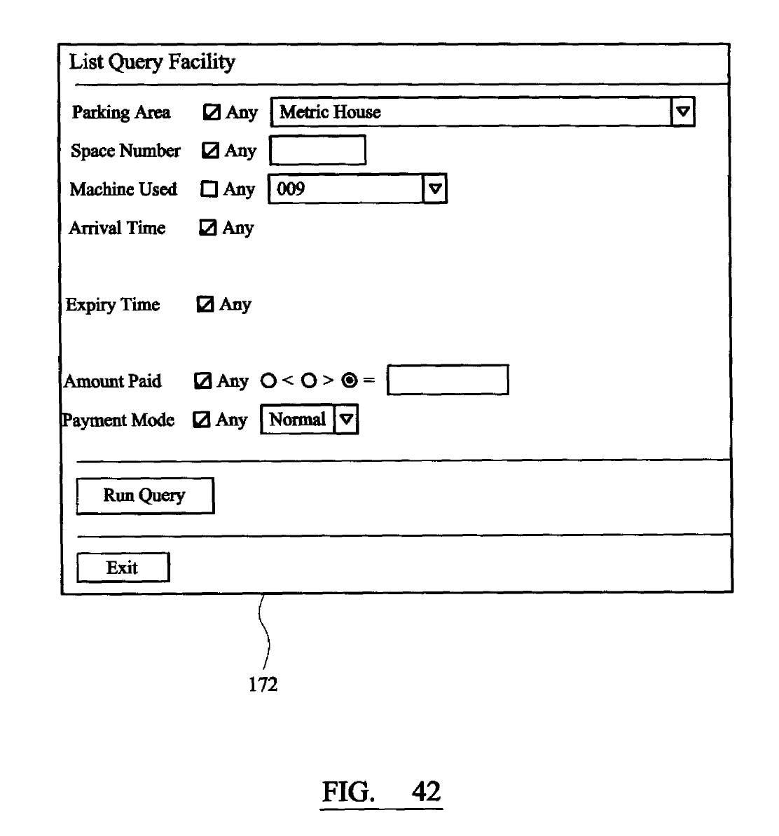

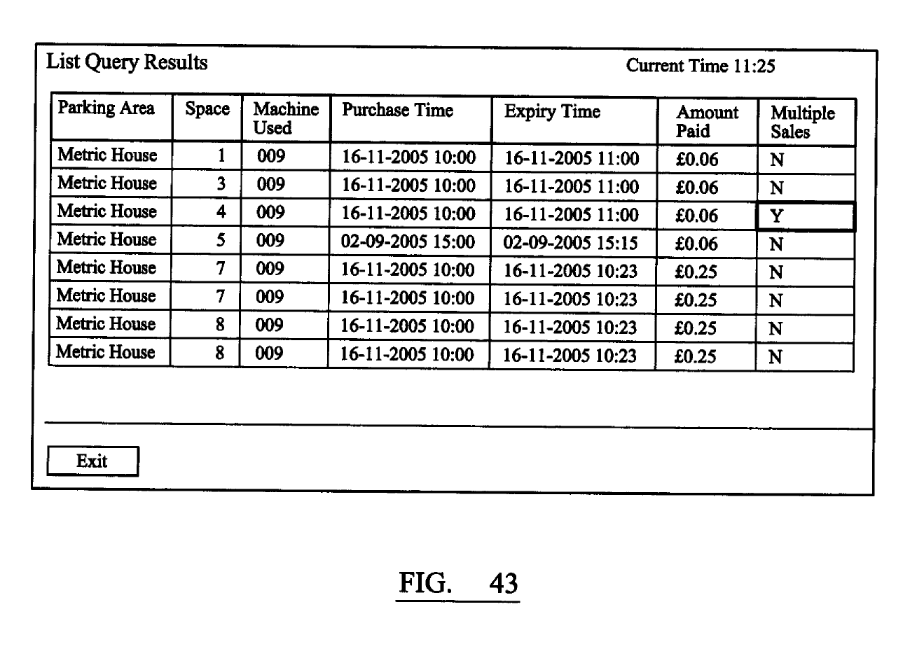

Clicking a query space list button 161, FIG. 28, displays a List Query Facility page 172, FIG. 40. With all of the ‘Any’ tick boxes ticked, clicking the run query button 173 will output all the space information held as exampled in FIG. 41.

As illustrated in FIG. 42, the List Query Facility page 172 can be set to output space information filtered for a particular machine, in this example for machine 009, the output shown in FIG. 43. Buy un-ticking one or all of the ‘Any’ tick boxes additional filtering can be applied.

An important field to note of is the one labeled ‘Multiple Sales’ this indicates that during the periods between the machine providing this information to the central server there was more than one transaction, using this specific space number. This field warns that only the most recent of these transactions is known any intermediate transaction information has been lost.

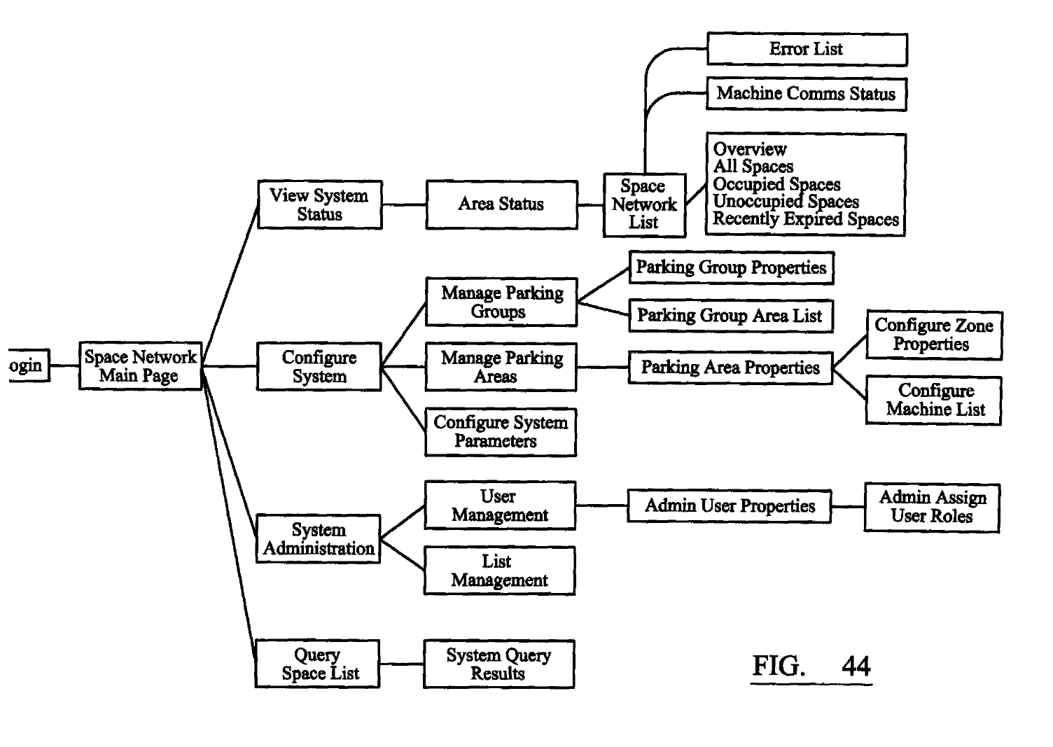

A summary of the system's functionality is shown schematically in FIG. 44.

Various alternatives or additions to the above embodiment may be envisaged, without departing from the scope of the invention as defined by the claims.

For example, in one alternative, the ticketing machines 4 and the portable terminal 9 use a WiFi network rather than a GPRS network to provide an Internet connection to the server 5. Other types of wireless networks for making this connection may also be used. In an alternative embodiment, the ticketing machines 4 do not have wireless capability and connect to the server 5 using a fixed line network.

Other types of machines rather than the ticketing machines 4 may be used to purchase parking time for the parking spaces and in doing so transmit information to the server 5. For example, in one alternative, it is envisaged that a user may use his or her mobile phone to connect to the server 5 to purchase parking time for a space and to transmit to the server 5 information identifying the individual parking space for which parking time has been purchased and information relating to the purchased parking time for the identified parking space.

Various other modifications of the specific embodiments may be envisaged, within the scope of the following claims.

Having thus described the present invention by reference to a preferred embodiment it is to be well understood that the embodiment in question is exemplary only and that modifications and variations such as will occur to those possessed of appropriate knowledge and skills may be made without departure from the spirit and scope of the invention as set forth in the appended claims and equivalents thereof. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements.

1. A method of operating a system for monitoring a status of vehicle parking spaces, said method comprising:
receiving at a server data transmitted over a network from at least one apparatus useable to purchase parking time for the parking spaces, the data comprising identity information identifying individual parking spaces for which parking time has been purchased and information relating to the purchased parking time for each identified parking space; and
transmitting from said server to a user terminal status information regarding said parking spaces for presentation to a user of said terminal, said information depending upon said data received at said server.

2. A method according to claim 1, wherein said status information identifies parking spaces for which parking time has been purchased and includes information indicative of an expiry time or period for the purchased parking time of each identified space.

3. A method according to claim 1, wherein said status information identifies parking spaces for which no parking time is currently purchased.

4. A method according to claim 1, wherein said status information identifies parking spaces for which purchased parking time has recently expired or will soon expire.

5. A method according to claim 1, wherein said status information transmitted to said user terminal is presentable to a user of said terminal in a list format.

6. A method according to claim 1 wherein said status information transmitted to the user terminal is presentable to a user of said terminal in a map format.

7. A method according to claim 1, wherein said user terminal is a portable or hand holdable terminal.

8. A method according to claim 1, wherein said at least one apparatus useable to purchase parking time for the parking spaces is a ticketing machine.

9. A method according to claim 1, wherein said data is transmitted to said server at least in part over a wireless communication network.

10. A method according to claim 1, wherein said status information is transmitted to said user terminal at least in part over a wireless communication network.

11. A method according to claim 1, wherein said data received at said server is received at intervals and newly received data is used to update previously received data.

12. A method according to claim 1, wherein the information transmitted from said server to said user terminal relates to a transaction or transactions for a specific space or specific spaces purchased using a specific apparatus or apparatuses or purchased between or on specific dates or times or having an expiry time between or on specific dates or times, or any combination of these.

13. A method according to claim 1, wherein the information transmitted from said server to said user terminal includes purchase price information or payment mode information relating to a transaction or transactions for a specific space or spaces.

14. A method according to claim 1 wherein the information is transmitted from said server to said user terminal in response to a request from the user terminal.

15. A method of operating a system for monitoring a status of vehicle parking spaces, the method comprising:
transmitting data from at least one apparatus useable to purchase parking time for said parking spaces over a network to a remote server, said data comprising identity information identifying individual parking spaces for which parking time has been purchased and information relating to the purchased parking time for each identified parking space;
receiving at said user terminal status information regarding said parking spaces, said status information transmitted from said server and being dependent upon said data transmitted from said at least one apparatus; and
presenting said status information to a user of said terminal.

16. A method according to claim 15, wherein said status information identifies parking spaces for which parking time has been purchased and includes information indicative of an expiry time or period for the purchased parking time of each identified space.

17. A method according to claim 15, wherein the status information identifies parking spaces for which no parking time is currently purchased.

18. A method according to claim 15, wherein said status information identifies parking spaces for which purchased parking time has recently expired or will soon expire.

19. A method according to claim 15, wherein said status information transmitted to said user terminal is presented to a user of the terminal in a list format.

20. A method according to claim 15 wherein said status information transmitted to said user terminal is presented to a user of said terminal in a map format.

21. A method according to clam 15, wherein said user terminal is a portable or hand holdable terminal.

22. A method according to claim 15, wherein said at least one apparatus useable to purchase parking time for said parking spaces is a ticketing machine.

23. A method according to claim 15, wherein said data is transmitted to said server at least in part over a wireless communication network.

24. A method according claim 15, wherein said status information is received by said user terminal at least in part over a wireless communication network.

25. A method according to claim 15, wherein said data transmitted to said server is transmitted at intervals so that newly transmitted data can be used to update previously transmitted data at the server.

27. A method according to claim 15, wherein said information transmitted from the server to said user terminal relates to a transaction or transactions for a specific space or specific spaces purchased using a specific apparatus or apparatuses or purchased between or on specific dates or times or having an expiry time between or on specific dates or times, or any combination of these.

28. A method according to claim 15, wherein said information transmitted from said server to said user terminal includes purchase price information or payment mode information relating to a transaction or transactions for a specific space or spaces.

29. A method according to claim 15 wherein said information is transmitted from said server to said user terminal in response to a request from said user terminal.

30. Apparatus for monitoring a status of vehicle parking spaces, said apparatus comprising:
a server for receiving data transmitted over a network from at least one device useable to purchase parking time for the parking spaces, said data comprising identity information identifying individual parking spaces for which parking time has been purchased and information relating to the purchased parking time for each identified parking space; and for transmitting to a user terminal status information regarding the parking spaces for presentation to a user of the terminal, said status information depending upon said data received at the server.

31. Apparatus according to claim 30, wherein said user terminal is a portable or hand holdable terminal.

32. Apparatus according to claim 30, wherein said at least one device useable to purchase parking time for the parking spaces is a ticketing machine

33. Apparatus for monitoring a status of vehicle parking spaces, said apparatus comprising:
at least one device useable to purchase parking time for the parking spaces and for transmitting data over a network to a remote server, the data comprising identity information identifying individual parking spaces for which parking time has been purchased and information relating to the purchased parking time for each identified parking space;
and at least one user terminal for receiving status information regarding the parking spaces transmitted from said server, the status information being dependent upon the data transmitted from said at least one apparatus, and wherein said user terminal is for presenting the status information to a user of the terminal.

34. Apparatus according to claim 33, wherein said user terminal is a portable or hand holdable terminal.

35. Apparatus according to claim 33, wherein said at least device useable to purchase parking time for the parking spaces is a ticketing machine

36. A computer program arranged to perform said method according to claim 1 when executed at the server.

37. A method of conducting a transaction for parking time for a parking space; said method comprising:
receiving as data input at an apparatus a first request from a user for a purchase of parking time for a parking space, said request including data identifying the parking space;
presenting an identification code to said user for subsequent use by said user to purchase additional parking time to extend a time period for the parking space purchased by said first request;
receiving as data input at an apparatus a second request from said user for a purchase of additional parking time to extend said purchased time period for said parking space, said second request including the identification code; and
checking the validity of said identification code to authorize the second request.

38. A method according to claim 37, wherein said identification code encodes an expiry time for said purchased time period.

39. A method according to claim 37 wherein said first request is received as data input by said user at a first ticketing machine at a first location and said second request is received as data input by said user at a second ticketing machine at a second location.

40. Apparatus for conducting a transaction for parking time for a parking space; the apparatus comprising:
means for receiving as data input a first request from a user for a purchase of parking time for a parking space, the request including data identifying the parking space;
means for presenting an identification code to said user for subsequent use by said user to purchase additional parking time to extend a time period for said parking space purchased by said first request;
means for receiving as data input a second request from said user for a purchase of additional parking time to extend the purchased time period for said parking space, the second request including said identification code; and
means for checking the validity of said identification code to authorize the second request.

41. Apparatus according to claim 40, wherein said identification code encodes an expiry time for said purchased time period.

42. Apparatus according to claim 40 said apparatus being a ticketing machine.

43. Apparatus according to claim 40 comprising a first ticketing machine at a first location for receiving the first request and presenting the identification code to the user and a second ticketing machine at a second location for receiving the second request.
